(19) United States
(12) Patent Application Publication
(10) Pub. No.: US 2006/0248182 A1
(43) Pub. Date: Nov. 2, 2006

(54) Formatted and/or tunable QoS data publication, subscription, and/or distribution including dynamic network formation

(75) Inventors: David H. J. Glassco, Surrey (CA); Jordan C. Glassco, Surrey (CA)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Polycentric Networks Corporation

(21) Appl. No.: 11/414,585

(22) Filed: Apr. 28, 2006

Related U.S. Application Data
(60) Provisional application No. 60/677,601, filed on May 2, 2005.
(60) Provisional application No. 60/677,593, filed on May 2, 2005.

(51) Int. Cl. G06F 15/173

(52) U.S. Cl. 709/223

(57) ABSTRACT

Various methods and apparatus for publishing, subscribing and distributing data, between intra and/or inter-organizations, in formatted, real-time, and/or tunable QOS manner, via one or more channels, over a dynamically formed network of server(s) and clients, serviced publishers and subscribers of the data, are described herein.

### RELATED APPLICATIONS

This non-provisional application claims priority to U.S. provisional application 60/677,601, filed on May 02, 2005, having the same title, and to U.S. provisional application 60/677,593, also filed on May 02, 2005, titled “Formation and/or Management of Data Publication, Subscription, and/or Distribution Networks”.

### TECHNICAL FIELD

The present invention relates to fields of data communication and data processing. More specifically, embodiments of the present invention are related to formatted and/or tunable QoS data publication, subscription, and/or distribution methods, apparatuses and/or systems. {QoS=Quality of Service.}

### BACKGROUND

Increasingly, more and more electronic devices are capable of being networked together. The technology research firm IDC, reports that an explosion in the world wide installed base of embedded computing devices is now well underway. By the year 2012, the IDC, a technology researcher, estimates a total of 17 billion devices capable of being networked will be in service, with most of them being capable of communication over the Internet:
appliances and toys—11,000 million
industrial/automotive—400 million
entertainment—1,300 million
handhelds—2,600 million
computers—1,080 million

The IDC also predicts one trillion RFID tags and sensors are likely to be available, and need to be tracked. Beyond the RFID projections made in the IDC study, there are countless analog and digital sensors, actuators and other real world devices that could provide more useful service if integrated with organizational systems and the edge of the Internet.

However, traditional switched IP wired and wireless networks that carry packet data are unaware of the application context of the data actually being carried. These networks are effectively ‘dumb’ networks, and generally lack quality of service (QoS) facilities or access control facilities or application network data formatting facilities that are tunable at the application level. Thus, they are not suitable for real-time applications.

Further, traditional communications middleware and newer web service based Enterprise Service Bus (ESB) systems tend to be complicated, expensive and require specialist skills to implement and operate, and thus unlikely to be able to support the desired growth in integration of heterogeneous networked devices with heterogeneous applications and heterogeneous data storage, messaging and other business systems and heterogeneous devices such as mobile PDAs, mobile phones, wireless sensor network devices and so forth that require application level information sharing and application level networking support in order to become interoperable across IP networks using an information-centric data sharing approach.

As a result, most real-time applications are unable to communicate with each other because their designs are typically based on proprietary real-time data formats and proprietary communication technologies that are based on inflexible and or non-interoperable wire-bound communication protocols or design-time-made hard-typed software objects that require system rebuilds in order to change data types at run-time. As the rapid rate of innovation in wireless, sensor/actuator and software development tools continues, combined with steady performance improvements in computing and communications, the real-time systems have become “application silos”, as some writers would describe them, resulting in widespread interoperability problems and retardation of the rate of heterogeneous device networking through shared real-time applications that telecommunicate over IP packet networks.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a simplified overview of the present invention, in accordance with various embodiments, by illustrating a Management Server in Area 1 of FIG. 1, Networked Client Applications and Network Server Application in Area 2 of FIG. 1, a Formatted Network Orchestration Service in Area 3 of FIG. 1 and a Message Stack in Area 4 of FIG. 1;

FIG. 2 illustrates a simplified network view of the present invention, in accordance with various embodiments;

FIG. 3 illustrates a software view of a Client (also referred to as the Agent) and of the Agent class model in accordance with various embodiments;

FIG. 4 illustrates a relational data storage model for the Management Server in accordance with various embodiments;

FIG. 5 illustrates an exemplary system suitable for use as a client and/or a real time server, in accordance with various embodiments;

FIG. 6 illustrates an end user interface of a Management Server Site facility for accessing accessible Agent Systems, in accordance with various embodiments;

FIG. 7 illustrates an end user interface of a Management Server Site facility for managing Agent Systems by a logged-in authorized user, in accordance with various embodiments;

FIG. 8 illustrates an end user interface of a Management Server Site facility for managing Agent Networks, in accordance with various embodiments;

FIG. 9 illustrates an end user interface of a Management Server Site facility for managing Agent Application Uploads, in accordance with various embodiments;

FIG. 10 illustrates an end user interface of a Management Server Site facility for managing Agent Data (XML) Schema, in accordance with various embodiments;

FIG. 11 illustrates an end user interface of a Management Server Site facility for managing Web Services resources, in accordance with various embodiments;

FIG. 12 illustrates an end user interface of a Management Server Site facility for managing a user's “My Account”, in accordance with various embodiments;

FIG. 13 illustrates an end user interface of a Management Server Site facility for managing RADDO Platform/Business Agent Accounts, in accordance with various embodiments {RADDO=Rapid Agent Development, Deployment and Operation};

FIG. 14 illustrates an end user interface of a Management Server Site facility for managing Embedded Agent Accounts, in accordance with various embodiments;

FIG. 15 illustrates an end user interface of a Management Server Site facility for managing Organization Accounts, in accordance with various embodiments;

FIG. 16 illustrates an end user interface of a Management Server Site facility for administering Server/Switch Grids, in accordance with various embodiments;

FIG. 17 illustrates an end user interface of a Management Server Site facility for an Agent Networks—Network Wizard, Step 1 of 2, in accordance with various embodiments;

FIG. 18 illustrates an end user interface of a Management Server Site facility for an Agent Networks—Network Wizard, Step 2 of 2, in accordance with various embodiments;

FIG. 19 illustrates a class model for a Server/Switch, in accordance with various embodiments;

FIG. 20 illustrates a model for intra/inter organizational information sharing using heterogeneous devices/networks, in accordance with various embodiments;

FIG. 21 illustrates a system object model overview summary, in accordance with various embodiments;

FIG. 22 illustrates a Site Service form and an Client/Agent SDK form setting negotiated QoS policies, in accordance with various embodiments; and

FIGS. 23-24 illustrates an Agent based Client/Agent applications, utilizing embodiments of the invention.

### DETAILED DESCRIPTION OF EMBODIMENTS OF THE INVENTION

Embodiments of the present invention include, but are not limited to, distributed servers and clients, and the methods practiced thereon, for formatted and/or tunable QoS data publication, subscription and/or distribution networks, having particular application to real time heterogeneous data publication, subscription and/or distribution.

In the following description, various embodiments will be described with some details to facilitate understanding. For purposes of explanation, specific numbers, materials and configurations are set forth. However, it will be apparent to one skilled in the art that alternate embodiments may be practiced without the specific details. In other instances, well-known features are omitted or simplified in order not to obscure these embodiments.

Parts of the description will be presented in terms, such as data, event, and so forth, consistent with the manner commonly employed by those skilled in the art to convey the substance of their work to others skilled in the art. As well understood by those skilled in the art, these quantities take the form of electrical, magnetic, RF, or optical signals capable of being stored, transferred, combined, and otherwise manipulated through electrical and/or optical components of a processor and its subsystems.

Various operations will be described as multiple discrete steps in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

Overview

A summary overview of the present invention is that it supports information-centric intelligent device networking and application networking over IP networks, and in various embodiments, contains one or more of each of three integrated service oriented systems:
1. Management Server 100—to enable organizations to dynamically specify and engage active rules and information assets for intra/inter organizational information sharing.
2. Networked Server Applications 103—to enable organizations to automatically share information in accordance with (declarative service contract) rules defined by organized users of the Management Server and dynamically used by Servers (also referred to as Switches) that host the Formatted Network Message Orchestration Service 107 at runtime. Agents communicate via the Network Message Orchestration Service in accordance with a distributed rules or “contract of service” framework at all times.
3. Networked Client Applications 104—to enable organizations to produce and consume information as an intrinsic part of real-world, geographically fixed, mobile and remote assets via the dynamic, abstract agent (device) networking services provided by the Networked Server Applications, the Network Message Orchestration Service and the Management Server.

Enabling Technologies

Embodiments of the present invention make use of one or more of three recently developed enabling technologies:
XML as a standard for heterogeneous data-types and;
Object-oriented language support for XML serialization and;
SOAP protocol use with WS-Security and WS-SecureConversation support. (WS=Web Services).

About XML as a standard for heterogeneous data-types:

The World Wide Web Consortium (www.w3.org) XML Schema language (XSD) 1.0 recommendation (XML Schema Part 2) defines requirements for a type system for language-independent data-types that is influenced by ISO 11404, supports SQL data-types and supports programming language data-types such as Sun Java and Microsoft .NET. (SQL=Structured Query Language).

About Object-oriented language support for XML Serialization:

Programming languages such as Microsoft .NET and Sun Java provide rich object-oriented, inheritance-based, software development capabilities that make it easier to integrate use of sensor and actuator based technologies, databases, applications and other computing resources with computers and computer based devices that run .NET or Java. Microsoft .NET and Sun Java provide built-in serialization capability to convert objects into a form that can be readily transported. Once serialized, an object can be transported over the Internet using HTTP between a client and a server, or vice versa, once received then de-serialized to reconstruct the object from the XML stream.

About SOAP protocol use with WS-Security and WS-SecureConversation support:

The OASIS Consortium Web Services Security (WS-Security) TC (Technical Committee) version 1.0 became a formal standard in April 2004 and provides a specification for a method for building integrity, confidentiality and authentication web service message applications using X.509 certificates and Kerberos. The Web Services Secure Conversation Language (WS-SecureConversation) specification, February 2005, was developed as a layer above WS-Security to provide secure communication between services and defines extensions that build on WS-Security (and WS-Trust) to provide secure communication across one or more messages by specifying mechanisms for establishing and sharing security contexts, and deriving keys from established security contexts or any shared secret.

About Development Languages that Support Both XML Serialization, WS-Security & WS-SecureConversation:

Currently, both Sun Java and Microsoft .NET support XML serialization and WS-Security and WS-SecureConversation.

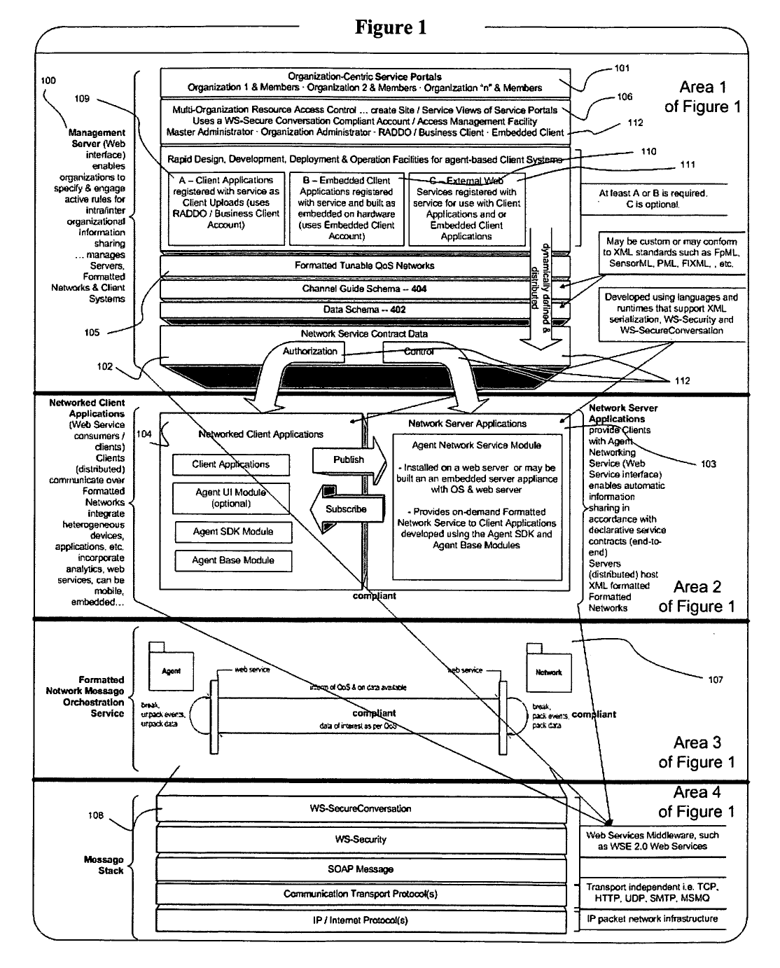

Referring now to FIG. 1, wherein a simplified overview of the present invention, in accordance with various embodiments, is illustrated. Area 1 of FIG. 1 illustrates a Management Server; Area 2 of FIG. 1 illustrates Networked Client Applications and Network Server Applications; Area 3 of FIG. 1 illustrates a Formatted Network Message Orchestration Service; and Area 4 of FIG. 1 illustrates a Message Stack.

As will be described in more detail below, embodiments of the present invention enable various Service Portals 101, manifested as Management Server Site Views 106 and corresponding real-time formatted data sharing Service Grid Data Distribution Service Views 106 to create various combinations of Service Contracts 102 that control and organize the formation of a Service Grid composed of one or more optionally distributed Network Server Applications 103 to be used to provide IP based communication service to various combinations of one or more Networked Client Applications 104. In various embodiments, the Network Server Applications 103 host real time Formatted Tunable QoS Networks 105 that provide real time communication services for real time Applications. In various embodiments, the Service Portals 101 are dependent upon a resource access control mechanism based on the use of WS-SecureConversation 108 compliant web service middleware and/or remote procedure call mechanism commonly referred to as “RPC” to control Networked Client Application 104 access to Formatted Tunable QoS Networks 105 via Networked Server Applications 103 that host WS-SecureConversation 108 compliant Formatted Tunable QoS Networks 105 which involves the use of a Formatted Network Message Orchestration Service 107 that is dependent upon a resource access control mechanism based on the use of WS-SecureConversation 108 compliant web service middleware underneath the message orchestration engine service endpoints at Agents (Networked Client Applications 104) and Networks (Network Server Applications 103).

Examples of real time networks may include, but are not limited to, Location, Speed, Light, Temperature, Mass, Acceleration, Chat Conversation, Contract Negotiation, Machine Vibration, Fuel Availability, Fuel Consumption, a physical object identified with RFID/Auto ID, Stock Quotes, and so forth. The concept of Service Portals is abstract and is manifested in various embodiments as different web site Views of data and web site service facilities that are made available by the Management Server, and, is manifested in various embodiments as different information-centric real-time formatted data information sharing planes (instantiated by Networks and Agents) where each Service Portal View is controlled by a organization membership mechanism and resource access control mechanism that makes use of shared secrets managed by WS-SecureConversation 108 sub-systems. Examples of Service Portals 102 may include, but are not limited to, Organization 1 and its user members, Organization 2 and its user members and so on for any number of Organizations and member users. In various embodiments real-time information sharing Views are defined at runtime through the use of RADDO/Business Client Accounts 109, Embedded Client Accounts 110. (The acronym “RADDO” refers to “Rapid Agent Development, Deployment and Operation”, thus describing a more life-cycle comprehensive “RAD” or “Rapid Application Development” specialized methodology for distributed IP communication enabled heterogeneous agent-based systems under organization-centric control.) In various embodiments web site Views are defined at runtime through the use of RADDO / Business Client Accounts 109. In various embodiments the use of External Web Services 111 may be integrated into web site Views and real-time information sharing Views through the use of RADDO/Business Client Accounts 109. In various embodiments the use of Master Administrator Accounts 112, Organization Administrator Accounts 112, RADDO/Business Client Accounts 112, Embedded Client Accounts 112 is controlled by a organization membership mechanism and resource access control mechanism that makes use of shared secrets managed by WS-SecureConversation 108 sub-systems.

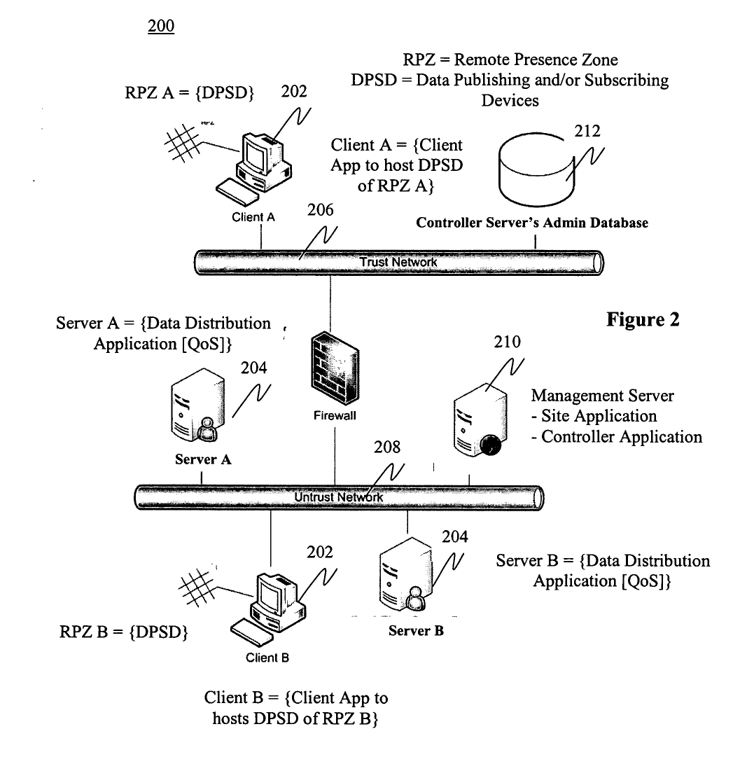

Referring now to FIG. 2, wherein a simplified network view of the present invention, in accordance with various embodiments, is illustrated. As will be described in more detail below, embodiments of the present invention include but are not limited to
a Networked Client Applications 104, and
a Network Server Applications 103,
   whose copies are installed on Clients (also referred to as Client or Agent) 202 and Servers (also referred to as Server or Switch) 204 respectively. As will be described in more detail below, Clients 202 are loosely coupled to Servers 204, meaning they may be coupled intermittently through the use of web service based messaging.

Two copies, each, are illustrated in FIG. 2. The two copies of Client Application (A and B) are installed on Clients A and B 202 respectively, whereas the two copies of Server Application (A and B) are installed Server A and B 204 respectively.

Client Applications A and B host Collections A and B of Data Publishing and/or Subscribing Devices (DPSD), respectively. In various embodiments, each collection of DPSD is located within a geographical area, referred to as a zone (in physical space-time) (also referred to as a remote presence zone or “RPZ”). The size of the geographical area is typically dependent on the communication mechanism employed for the particular collection of DPSD and its host Client. In various embodiments, the DPSD of a collection may optionally communicates wirelessly with their host Client. In various embodiments, the DPSD are real time DPSD, such as sensors, actuators, and so forth.

Server Application A and B cooperate with each other to provide Data Distribution Service (also referred to as information-centric real-time formatted data information sharing planes) for Clients A and B (in turn, their DPSD). In various embodiments, Client and Server Applications are designed to support formatted data publication, subscription and/or distribution. In various embodiments, Client and Server Applications are designed to support tunable QoS data publication, subscription and/or distribution.

As illustrated, Servers A and B 204 and Clients A and B 202 may be coupled to each other via trusted and untrusted 206 and 208, private and/or public networks (such as the Internet). Together, they form a formatted and/or tunable QoS Data Publication, Subscription and/or Distribution Network (DPSDN), hereinafter simply referred to as Network.

In various embodiments, as illustrated, the present invention further includes a Management Server 100 that in various embodiments further includes
a Site Application sub-system (partly explained by 101), and
a Controller Application subsystem 112.

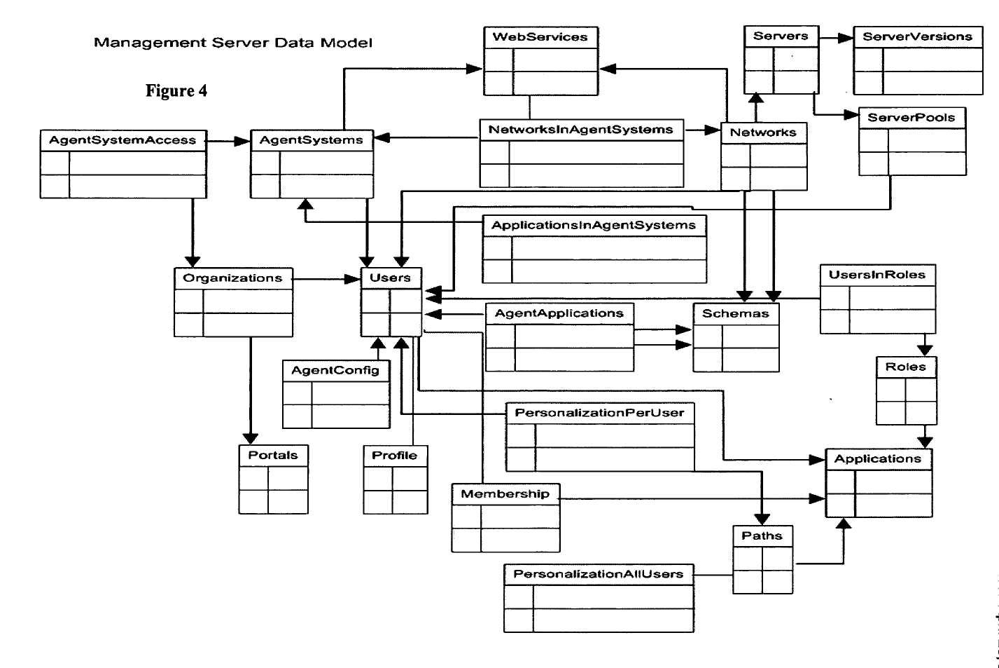

For the illustrated embodiments, Site and Controller Application sub-system is installed on a Management Server 210. The Management Server may likewise be coupled to the earlier described Servers and Clients 202 and 204 via the same or different trusted/un-trusted 206 and 208, private/public networks. For the embodiments, Management Server Application has an associated Administration Database 210, which may be located behind a trusted network 206. For the embodiments, the Administration Database 210 persists, or stores, the Account 112 credential data and Network Service Contract 102 data and other data. In various embodiments, these data are organization as summarized in the exemplary Management Server Data Model Illustration FIG. 4. For the embodiments, note that FIG. 4 shows a Microsoft ASP.NET 2.0/SQL Server 2005 data model report and also note that for the illustration of the embodiments that Microsoft ASP.NET 2.0 is WS-SecureConversation compliant. In alternate embodiments, the Account 112 credential data and Network Service Contract 102 data and other data may be organized and stored employing other data organizations.

The Management Server Application facilitates distribution of real-time Agent Systems, consisting of heterogeneous Networks and real-time Applications, to users who are also associated with Organizations and where such Applications have been made available to them from Service Portals 102. The Management Server Application also facilitates operations management of the real-time Service and administrative management of Service Access. The Management Server Application is used through the Management Server Web Site to manage the dynamic formation of the Networks 200 20 hosted by computers registered for service with the real-time Service Grids. Resultantly, the example Network 200 illustrated in FIG. 2 may be dynamically formed. Further, the various Networks dynamically formed using different Servers and Clients 102 and 104 (i.e. other servers and clients not shown) may publish, subscribe and/or distribute data of different data format, i.e. the Networks 200 are heterogeneous.

Before proceeding to describe Management Server, Client Application, Server Application, and other related aspects in further detail, it should be noted that while only one DPSDN with two Servers 204 and two Clients 202 are shown, the invention is not so limited. Depending on the hardware resources provided, multiple Networks 200 may be concurrently supported, with each having many more Servers 204 and/or Clients 202, supporting a multitude of DPSD, including in particular, real time DPSD.

The Management Server Application

In various embodiments, the Management Server Application is designed to support concurrent use over the Internet or private networks by a relative large number of users. In various embodiments, the Management Server Application is designed for access using web browsers. In various embodiments, the Management Server Application is designed to support many different organizational affiliations. Thus, Site users may be able to access the Site and Site Portals from anywhere, through the Internet and/or from private networks.

In various embodiments, the Management Server Application 100, Networked Client Applications 104 and Network Server Applications 103 presume use by four types of Accounts
a Master Administrator Account
an Organization Administrator Account
a RADDO/Business Client Account and
an Embedded Client Account

In various embodiments each Service Domain has only one “Master Administrator Account”. In various embodiments, the Master Administrator Account is enabled to
Manage the Service Domain
Create “Organization” records
Create “Organization Administrator Accounts”, for an Organization record
Enable “Organization Administrator Accounts” with optional RADDO menu facilities
Delete an “Organization record, which in effect disables access by the Organization but does not delete data

In various embodiments, an “Organization Administrator Account” can only be created by the Master Administrator Account and an Organization Administrator Account may login through his/her Organization's Login page. In various embodiments, an Organization Administrator Account is enabled to
Create other “RADDO/Business Agent Accounts” belonging to his/her Organization
Enable “RADDO/Business Agent Accounts” with optional RADDO menu facilities
Use Agent Systems enabled for his/her Organization
Create Embedded Agent Accounts as child accounts of his/her Account

In various embodiments, a “RADDO/Business Agent Account” is enabled to
Use authorized RADDO facilities and Agent Systems
Use Agent Systems that have been enabled for his/her Organization
Create Embedded Agent Accounts as child accounts of his/her RADDO/Business Agent Account, if so authorized

In various embodiments, an Embedded Agent Account may be created by a RADDO/Business Agent Account or other Account so authorized to use the facility. For the embodiments an Embedded Agent 110 is capable of being remotely managed via the Service Portal 101 View 106 that owns it due to the system's distributed use of WS-SecureConversation 108 compliant Embedded Agents 110. In various embodiments, Embedded Agents are required to have Embedded Agent Accounts to access communication service. For the embodiments service access information is propagated by the Management Server Controller 112 sub-system in the form of Network Service Contract Data 102.

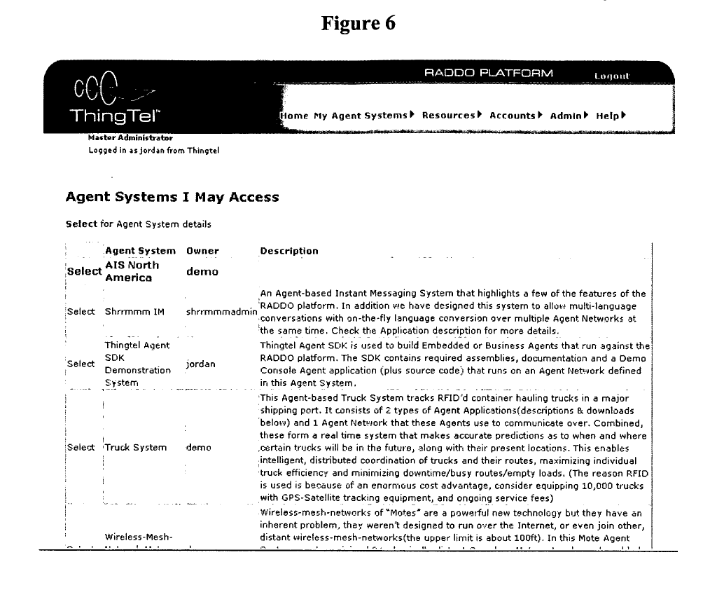

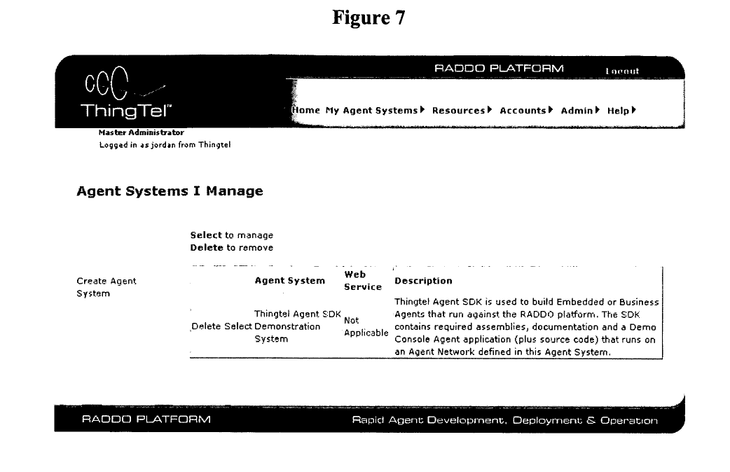

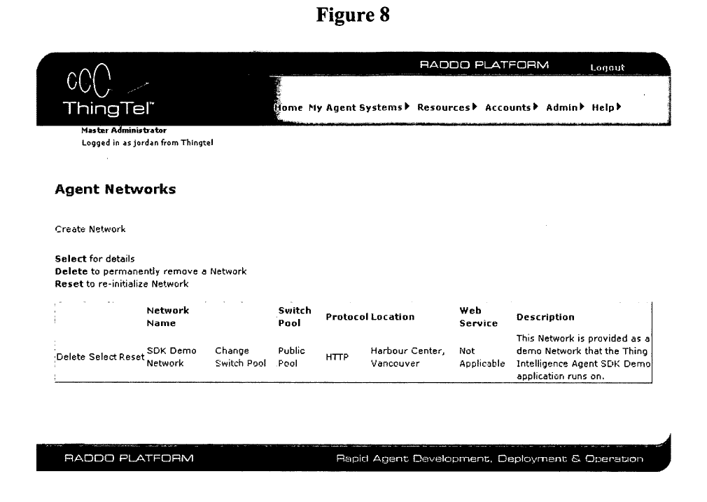

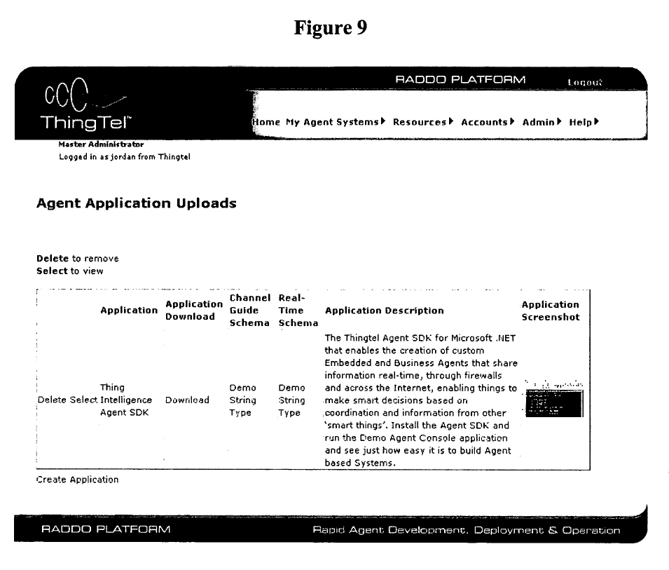

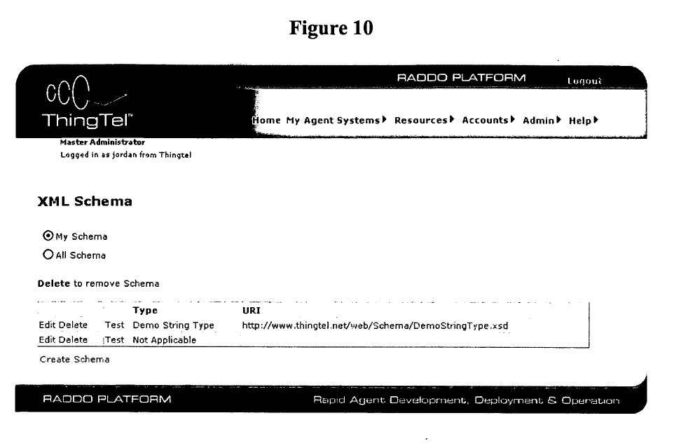

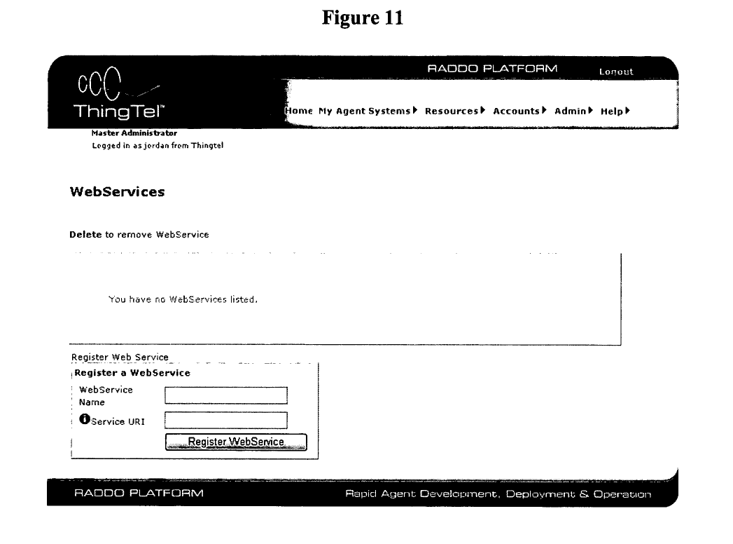

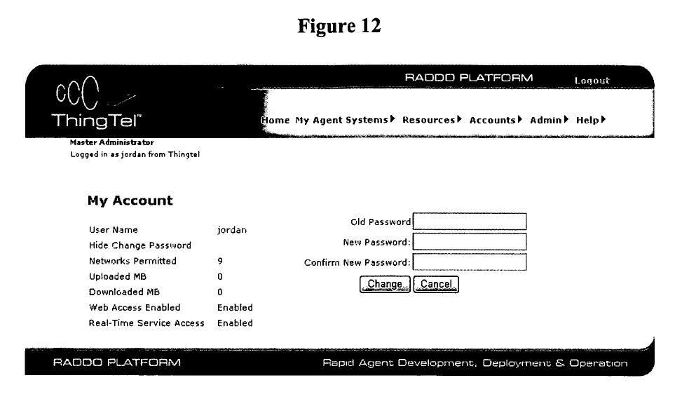

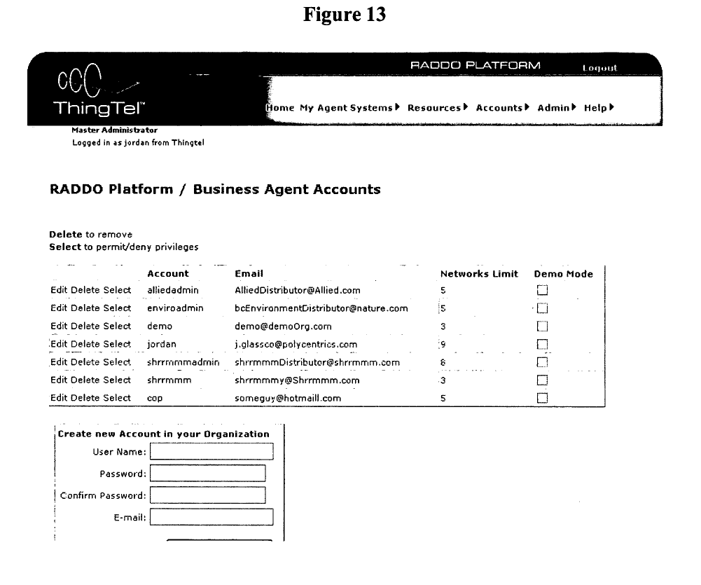

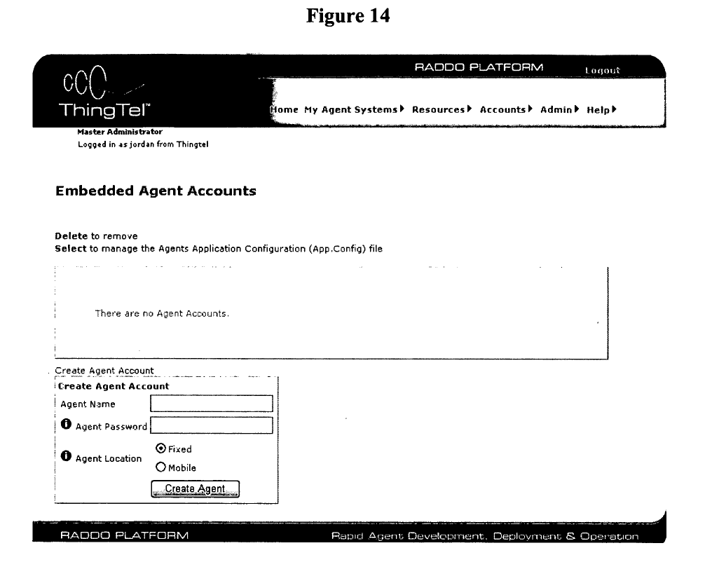

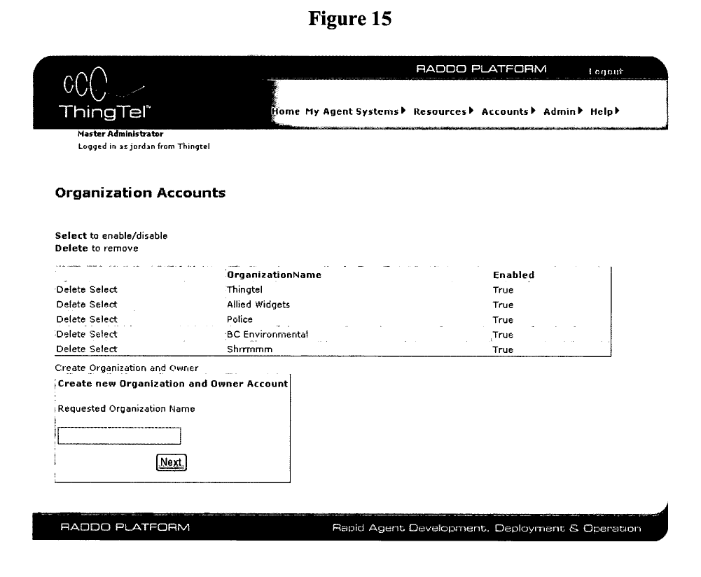

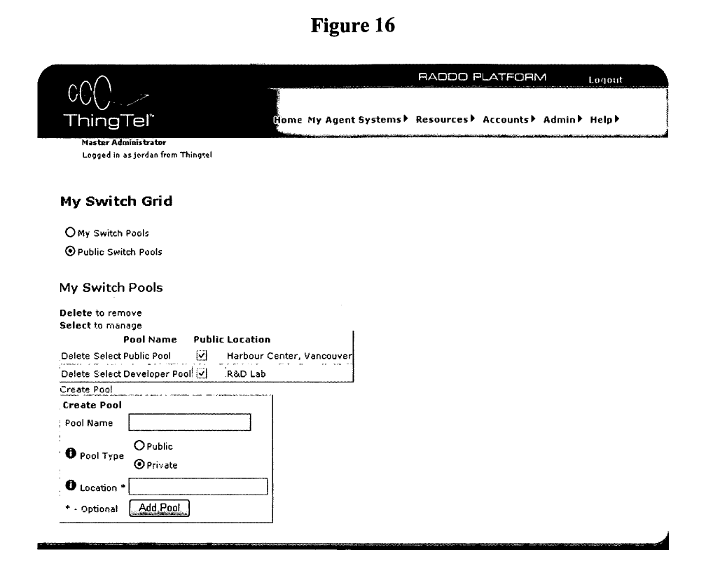

As an illustration of various embodiments the Management Server Site 100 may provide the following of service facilities
Account Application (optional use, enables anonymous users to apply for user account, in various embodiments approval may be automatic of subject to other defined approval process)
Login (enables Site login using username and password credentials)
Home (provides facilities to manage Agent Systems the user may access), FIG. 6
My Agent Systems
   Agent Systems I Manage (provides facilities to manage Agent Systems the user owns and provides facilities to manage), FIG. 7
   Agent Networks (provides facilities to manage Agent Networks the user owns and that the user may use), FIG. 8
   Agent Application Uploads (provides facilities to manage Agent Applications registered with the Service and stores the application binaries), FIG. 9
Resources
   Data (XML) Schema (provides facilities to manage Channel Guide Schema 404 and Data Schema 402), FIG. 10
   Web Services (provides facilities to manage External Web Services 111), FIG. 11
Accounts
   My Account (provides facilities to manage such Account details), FIG. 12
   RADDO Platform Business Agent Accounts (provides facilities to manage such Accounts), FIG. 13
   Embedded Agent Accounts (provides facilities to manage such Accounts), FIG. 14
   Organization Accounts (provides facilities to manage such Accounts), FIG. 15
Admin
   Switch Grid (provides facilities to manage various Service Grid assets comprised of Network Server Applications 103, also referred to as “Switches”), FIG. 16
   Appliance IP Settings (provides facilities to manage the IP settings for hardware hosting the Management Server 100),
Help
   Read Me (provides documentation for a specific build),
   Agent SDK Class Reference (provides online documentation for the Agent SDK),
   RADDO Platform Guide (provides online document for the system),
Logout (terminates the session)

In various embodiments, accounts such as the “Master Administrator Account” or the “Organization Administrator Account”, since such accounts are empowered to create other accounts, then at the time of account creation the user creating an account may assign any combination of Management Server Services as account privileges as follows
Real-Time Service Enabled (Yes, No)
Web/RADDO Site Enabled

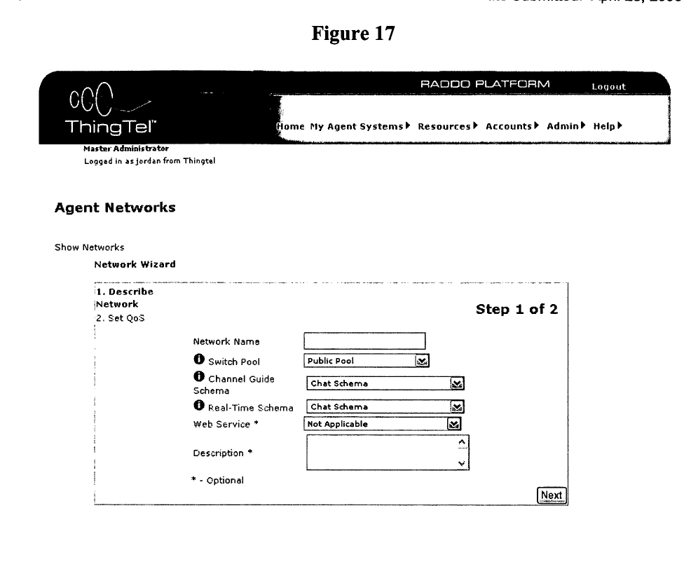

In various embodiments, accounts such as the “Master Administrator Account” or the “Organization Administrator Account”, since such accounts are empowered to create other accounts, then at the time of account creation the user creating an account may assign any combination of Management Server Site Service facilities as account privileges as follows
Account Roles (Yes, No), FIGS. 12, 13 and 15
AgentSystems (Yes, No), FIG. 7
Schemas (Yes, No), FIG. 10
Networks (Yes, No), FIG. 8
Applications (Yes, No), FIG. 9
Web Services (Yes, No), FIG. 11
Switch Grid (Yes, No), FIGS. 16 and 17
Embedded Agents (Yes, No), FIG. 14
Help (Yes, No),

In various embodiments the Management Server Application makes use of a web server and thus may also make use of an Anonymous User account. In various embodiments, the Account Application facility may enable People to first identify themselves when applying for access to Service and then to provide various personal related information, such as contact information. In various embodiments, the Account Application facility may enable Accounts to be granted to People upon approval (e.g. by an administrator with authority). In various embodiments, each Account has a unique login name and password that is used to validate Service access. The creation of such Accounts may be subjected to an Account Approval process.

Networks—Upon creation, Networks are assigned to an Organization. Networks are created instantly, on-demand by the Service to provide real-time communication services to Client Applications.

Applications—In various embodiments, Applications are made available as downloads to Users who may members of one or more Organizations. Examples of Applications include but are not limited to real time chat applications, environmental monitoring applications and so forth.

In various embodiments, the Management Server Application may be an ASP.NET 2.0 application. One such implementation of the Management Server Application is described as follows.

Management Server Application Example

Site Access—Access to the Management Server Application, in various embodiments, is granted by the system upon approval, by the system, of the user's access credentials. In various implementations, a Username and Password pair of unique strings, once access has been approved by the system, serves as a valid access credential, or valid access code. Multiple valid access codes are referred to as ‘credentials’. In various implementations, Site access credentials and Real-Time Service access credentials are treated as “Service Credentials”. Thus, a Username and Password can be used to login to the Site and through any Agent based application to the Real-Time Service managed by the Site. The Service permits multiple concurrent logins using the same access credential to the Site and to any number of Real-Time Agent based applications. However, the Service does permit the setting of a ceiling on the number of Real-Time Networks that a user may have access to through their Account.

Account Roles—Accounts when created must be assigned Roles. The assignment of Roles is done by an Account possessing a Role of higher authority.

Service Grid—The Service Grid form/facility is designed to organize a service grid consisting of one or more computers. In various embodiments, the form provides a tool that can be used by the Operator to add, delete or modify administration details corresponding to one or more computers. The form managed the data using a table with the following columns of information:
Server Name—a descriptive name for a computer, the job of which will be to host an instance of the Agent Network.
Service Address—the URI (using i.e. http:∥localhost|service or www.polycentrics.net or www.polycentrics.net|service or http:∥66.154.98.41|service, etc.). Service address must be capable of being Pinged from the IP location used to host the Management Server Application. (The “/”s in the example URI were replaced with “|”)
Protocol—being one of “TCP”, “HTTP”, or “BOTH” corresponding to the transport protocol used by the web services middleware and without limitation and/or other RPC mechanisms used in this implementation.
Username—a “Username” to use as part of the remote login credentials for the remote (or local) Real-Time Server.
Password—a “Password” to use as part of the remote login credentials for the remote (or local) Real-Time Server.
Location—a text string to identify the physical location of the remote (or local) Real-Time Server. Examples being “PolyCentrics Test Server # 1 at BC Hosting, Vancouver”, “Ocean Weather Watch Server # 1 at ServePath, San Francisco”, “Microsoft Main Data Center, Redmond”, “Blade 5 of 10 on Blade Server Betsy in Co-location 12, Denver”, “Mobile ER Server on NYFD Mobile Vehicle # 242”, etc.
Status—having two possible values, either “Up” or “Down” to report on Server status. The Real-Time Server reports it is able to distribute real-time XML data when “Up” and unable to do so when “Down”.
Activate/Suspend—a control facility to permit access “Activate” or deny access “Suspend” to a specific Real-Time Server. The default setting is “Activate”, which when used, returns a confirmation of Status=“Up”. The explicit use of “Suspend” causes the Real-Time Server to immediately deny Real-Time Service requests (by Applications) and to confirm such remote state with a status report of Status=“Down”.

Refer to Illustration for details.

Site Root Home Page—In various embodiments, on the Site Root Home Page, the following forms/facilities are provided:

Account Application—In various embodiments, the Account Application form/facility is designed to capture account application requests from anonymous users. The application approval process may be integrated with a third party online payment processing service such as provided by PayPal or other ePayment processing services but this is not a requirement. In various implementations, the Account Application form/facility is designed to collect the following data:
Username—a Username requested by the applicant.
Password—a Password requested by the applicant.
Confirm Password—a confirmation text string.
Email—the applicant's email address.

Login—In various embodiments, the form is designed to capture the following information:
Username
Password
Email
Remember me (checkbox)
And Login event.

In various embodiments, the Manage Accounts form/facility is designed to have the following controls on it:
Account Applications—are designed to display received Account application requests that originated from Account Application controls on the Site Root Home Page or individual Portal Site Home Pages. Displays, properties such as Username, Email and Account Type. Using a ‘toss-box’ mechanism can contribute record copies to an adjacent “Accounts Approved” control.
Accounts Approved—is designed to work with “Account Applications” control. Shows the same properties. Sets a record tag, “Approved”.
Assigned Privileges—for a selected Account, is designed to have “Approved” status, enables the setting of:
   Web Site access to be enabled (yes, no)
   Real-Time Service access to be enabled (yes, no)
   Displays Account type
   Number of Networks Allowed limit to be set (an integer)
   Set Network Default Use Rule (applies to Networks Account has gained access to via Account's membership in one or more Organizations), thus permitting the Account to:
      Set Default Access
         Publish Real-Time XML streams to all Networks
         Subscribe to Real-Time XML streams from all Networks
         Both Publish and Subscribe to Real-Time XML streams from all Networks
      On OverRide—property setting to mark if the Account's default settings have been over-ridden by use of the “Set Specific Network Access Controls” tool.
      Set Default—event trigger button.
Set Specific Network Access Controls—a control that enables the over-ride of default settings set by Network Default Rule. Enables editing of table that contains the following columns of information: “Organizations”, “Networks”, Can Publish (yes/no), Can Subscribe (yes, no), Can Publish & Subscribe (yes, no).

Agent System Wizard—In various embodiments, a multi-step process for defining Agent Systems for potential distribution to Organization users by the Portal hosted by the Site Service, is provided (FIG. 7).

In various embodiments, the facility is designed to enable the step by step specification of:
1. Select Agent System—presented as a list box control, that lists “Agent Systems” previously registered with the Service. The first record is always tagged “New” and selection of it creates a new “Agent System” record that can be named by the entry of a text name. Selection of any Agent System record instructs the wizard to apply subsequent Wizard settings to the record sets bound to the selected Agent System.
2. Register Schemas—enables the registration of XML schemas with the Real-Time Service. Schema Names and the Schema URIs must be specified for each of the (real-time) Data Schema and the Channel Guide Schema.
3. Network Description—a simple text string to give the XML Network a unique name.
4. QoS Policies—The QoS Policy Tool, is a user interface Site tool that can be extended to accommodate any number of variation of QoS Policies (refer to Managing QoS regarding extensibility feature) to be used in a implementation. In the current implementation, the QoS Policy Tool manages the following QoS Policies:
   a. Time QoS Policies include “Deadline”, “Latency Budget”, “Liveliness” and “TimeStamp”.
   b. Other QoS Policies include “Destination Order”, “Reliability”, “History”, “Ownership”.
5. Server Setup—enables specification of “Network Access” as (“Public”, “Private”), “Real-Time Server Host Computer” as (“Automatically Selected” by the Service, “Manually Selected” from a list of computers in the Grid)
6. Register Application—enables the setup of Agent based applications for use with the Real-Time Service. Information to be specified includes:
   a. Application Name
   b. Download URI
   c. Channel Guide Schema (Name)
   d. Real-Time Data Schema (Name)
   e. Application Description
   f. Application (showcase) Screenshot (image)

Agent System Reports—In various embodiments, the Agent Systems Reports facility is designed to provide Master/Details reporting on the following entities of information:
Agent Systems
Schemas
Networks
Servers (also referred to as Switches)
Applications

Distribute Agent Systems—In various embodiments, the Upload Agent Systems form/facility is designed to enable developer user to make Agent Systems available to selected Organizations hosted by Service Portal. Organizations, having been previously created using the Manage Organizations form/facility are listed in a “Organizations” list control that displays organization name and description. The control enables one organization to be selected at a time and for the organization selected the user may then select from all “Available Agent Systems” (previously made available by the Agent System Wizard) and tag the selected Agent System marking it for distribution to the selected Organization. The act of distribution causes the system to make Networks and Applications available to selected Organizations.

My Agent Systems—In various embodiments, the My Agent Systems form/facility is designed to list Agent System previously uploaded enables the user to download the Application by clicking on the Download (URI) hyperlink.

My Account—In various embodiments, the My Account form/facility is designed to enable an Account password to be changed and reports on Service permissions and use. The following information is managed by this form: User Name, Account Role, Old Password (edit box), New Password (edit box), Confirm Password (edit box), Networks Permitted, Uploaded (kilobytes), Downloaded (kilobytes), Web Access (enabled, disabled—if disabled then page can't be seen by user), Real-Time Service Access (enabled, disabled), Organizations Joined, Agent Systems downloaded, Networks Subscribed and Membership Date. FIGS. 12-15 illustrate various example graphical end user interfaces that may be employed for defining People, Account, Organization and Networks, in accordance with various embodiments.

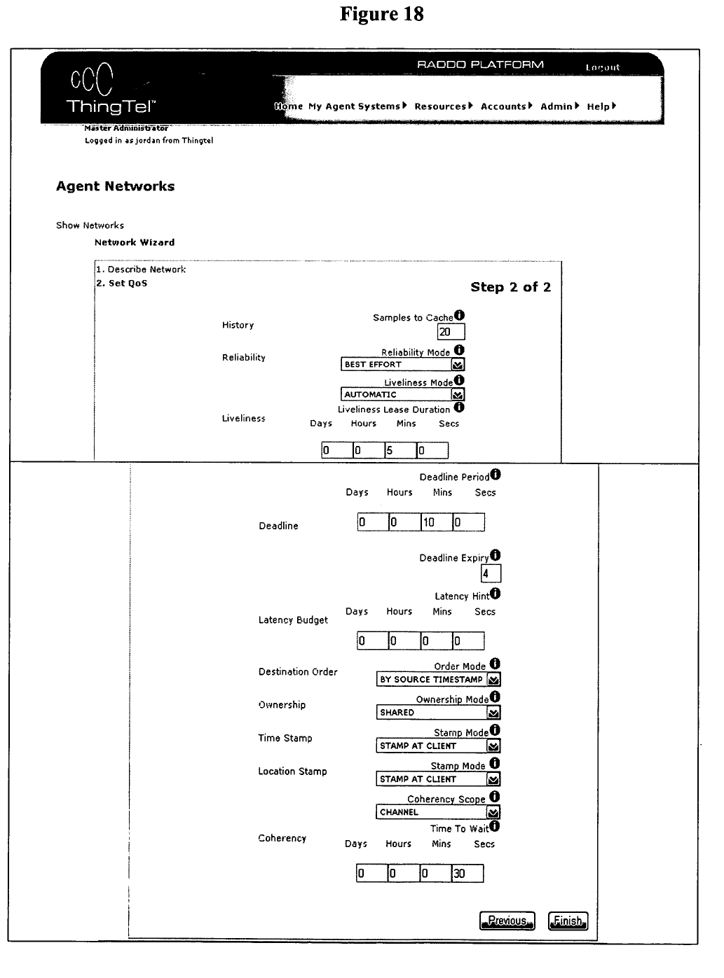

Agent Network Wizard—In various embodiments, a multi-step process for defining Agent Networks for potential use by Organization users of the Site and Service, is provided. Example graphical end user interfaces of an Agent Network Wizard, in accordance with various embodiments, are illustrated in FIG. 17 and FIG. 18.

The Management Server Application

The Management Server Application synchronizes Account access information and organizes computer resource hosts running the Server Application, so that the DPSD of the various RPZ, the Clients and the Servers collectively form an instant on-demand (real-time) Data Distribution Networks as a single distributed on-demand Service accessible through a single service access point via a URI that identifies the Service Domain.

The Management Server Application provides a facility to grant Network access to Accounts in good standing. An Account in good standing is an account that has been approved for active use. The Management Server Application automatically synchronizes Admin Database data with Servers (also referred to as Switches).

The Admin Database provides persistent storage for the Management Server Application. In various embodiments, the Admin Database is installed on a computer assigned to a network Trust Zone. In various embodiments, the Admin Database contains one or more tables for storing account login credentials, account role assignments, Network configuration data such as QoS settings and other information. In various embodiments, the Management Server Application automatically propagates operational data stored in the Admin Database to the Servers that host administered Networks as Service Contract 102 datasets. In various embodiments, Data may also be pushed out manually from the Management Server as Service Contract 102 datasets.

The Serveir Application

Also referred to as Network Server Applications 103, Servers 210 in cooperation with the Management Server Application 100 produce the Service that provides substantially instantaneous accommodation of one or more data formats. In various embodiments, the one or more data formats may include one or more heterogeneous XML data formats. Server 210 creates Networks that in turn host Channels that automatically distribute (XML) formatted (real time) data streams from Publishers to Subscribers having been granted access to such Networks. Publishers and Subscribers are hosted by the Client Applications 104.

As described earlier, in various embodiments, data distribution QoS is configurable (i.e. tunable). In various embodiments, graphical controls and programmatic APIs may be provided at the Network level and/or at various levels at the Client 202. In various embodiments, Data distribution QoS is distributed and dynamically negotiated at run-time between Clients 202 and Servers 204.

In various embodiments, Networks are ‘created’ (also referred to as initialized) by the Management Server Application. At the time of creation, Networks are assigned a Server (or a number of Servers) 210 that will be responsible for the Networks life, and at the same time are assigned the Network's data definition schema. In various embodiments, the Network's data definition Schemas, namely Channel Guide Schema 404 and Data Schema 402 are XML schemas. In various embodiments, the schemas may be stored on a secure or un-secure web server or may be stored and distributed by a Management Server application. In other words, for these embodiments, the Server or Servers 210 are provided with the storage locations (e.g. in the form of URLs) of the applicable schemas.

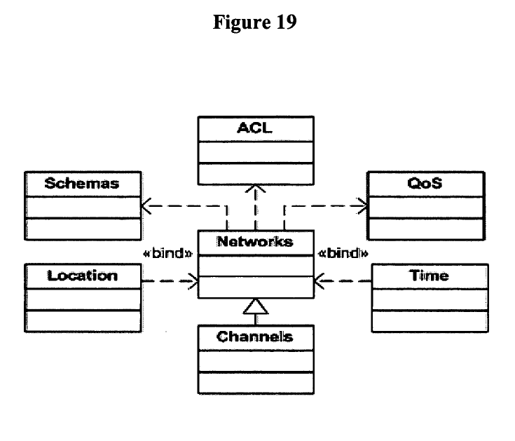

In various embodiments, once the first Client 202 is registered with a Network, a Service automatically (retrieves the schemas, and) delivers schemas, upon first use, to Clients 202, upon their indication of interest in the Network. In various embodiments, the schema is incorporated with QoS model, and optional automatic data validation services may be provided. The Service is capable of providing distributed, QoS assured, automatic (real-time) data distribution services through firewalls for (real time) data streams, which may be heterogeneous. Communication services (e.g. real time communication services) are provided by the implementation of orchestrated web services. To illustrate the embodiments, FIG. 19 shows a simple object class model to be used in the Server (also referred to as a Switch) (FIG. 19, illustrates the relationships between the Networks, QoS, Time, Channels, Location, Schemas and ACL (also referred to as “Access Control List” classes). In various embodiments, Network Service Contract 102 dataset information is pushed out to Servers by the Management Server to populate the Networks, QoS, Time, Channels, Location, Schemas and ACL entities with runtime Service control policies and other information.

The Client Application

The Client Application 302 (also referred to as Networked Client Applications 104) enables (real time) Applications to have access to an always-on, dial-tone-like (real-time) communications service that operates through firewalls. In various embodiments, the Client Application 302 includes an Agent 304, a runtime component that provides adaptive access to the Service. The Service provides automatic real-time data distribution via instant, on-demand Networks.

Each endpoint Client Application 302 may host any number of Publishers (i.e. sensors, text writers, calculation return processes) or Subscribers (i.e. actuators, text readers, calculation input processes). Endpoint Publishers send data to Subscribers at other endpoints via Networks. Network Channels receive Publisher data as (XML) formatted data streams and automatically distribute it to interested (and authorized) Subscribers (in real-time). A source of stream data might originate e.g. from a series of keystrokes sending text data strings to a chat application or a wireless sensor network producing temperature, GPS, RFID or other sensor data streams. This mechanism enables different applications connected to different electronic devices, back-end systems or human interfaces (forms and interactive applications) to share complex, sometimes inter-dependent information, expressed in (XML) data formats (defined as Channel Guide and Data Schemas), which may be heterogeneous, that are routed over (XML) data type-bound communication planes.

In various embodiments, Publishers and Subscribers share (real-time) data streams that leave a Publisher in a particular (XML) data format, and automatically arrive at Subscribers in the same(XML) data format via shared Networks under agreed-to service delivery QoS contracts negotiated between participating Agents and the Service.

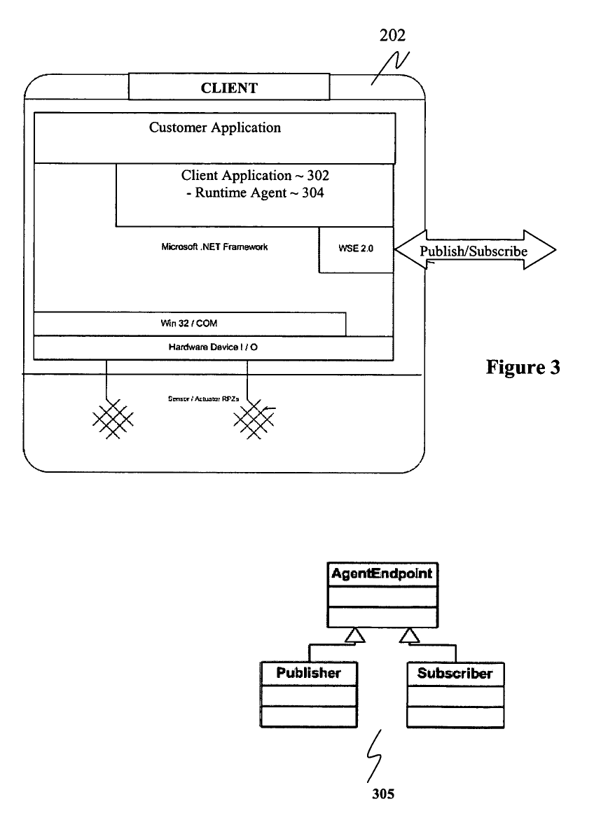

FIG. 3 illustrates a software view of the components on an example Client 202, in accordance with various embodiments. For the embodiments, Client Application 302 employs various available underlying system services, such as those available from WSE 2.0, and Microsoft's .Net platform. To illustrate the embodiments, FIG. 3 shows a simple object class model to be used in the Client (FIG. 3, illustrated item 305, relating the AgentEndpoint, Publisher and Subscriber classes).

Networks As A Service

As described earlier, Networks 200 of the present invention carry application information that are formatted, e.g. in XML, and carried as streams of (XML) data samples. Further, Networks 200 operate automatically in accordance with application tunable QoS. QoS facilities represent Service logic that is shared by distributed application agents. Agent-based applications provide adaptive Service based on the context and circumstance of use. This adaptive Service is made available as a distributed service presence, a kind of smart, adaptive service backplane made possible by the Service Grid. In various embodiments, it is based on XML.

The approach makes it easier to develop, deploy and manage distributed (real-time) applications that can be integrated with business systems, make use of sensor or actuator devices at the edge of the Internet and that cooperate via tunable QoS data distribution, access and process handling services.

Networks 200 of the present invention are created on-demand by the Service in response to use of the earlier described Management Server Application. Users in e.g. a Network Manager Role can use the Management Server Application to set the (XML) data format and QoS policies for any Network. Once satisfied with a Network setup, a Network Manager can simply log out and any authorized user can use the Network. The Management Server Application automatically synchronizes Admin Database data with the Servers managed by it.

The Service provides data distribution services to authorized Client endpoint applications using the publish and subscribe model. The Networks 200 automatically route and stream (XML) data in response to Publisher and Subscriber endpoint requests (e.g. for real-time service). Networks 200 create and host, on-demand, any number of (real-time) (XML) data channels that share one or more of:
a (real time) Data Schema 402 and a Channel Guide Schema 404 (registered with the Service as URI's to whatever schema chosen)
a set of predefined, tunable QoS (Quality of Service) policies
a common access list (of authorized ServiceEndpoint accounts)

Networks 200 then carry data streams of a particular (XML) data type (Channel Guide 404 & Data Schema 402) and automatically distribute data in accordance with the QoS policies that have been set for it. This enables a single Server (or a number of Servers) 210 to provide specific QoS support for many Networks at the same time where multiple Networks may have same or different data formats and multiple streams may require coherent handling treatment.

Networks 200 provide on-demand service, remaining alive but inactive until at least one Client endpoint 202 starts pumping data into that specific Network 200. Networks 200 are intended to be long-lived so that they will be available to provide service as long as the specifications for them are present in the system. Networks 200 remain always ready to service endpoints until the expiry of the Network lease period.

Under the Service model, Publishing and Subscribing Clients 202 make use of Service Portals by discovering or declaring a target Network of interest (e.g. “Shrrmmm_Chat_Room”) . . . and then upon authorization to the specific Network 202, the Endpoint negotiates QoS with the Network, and if successful, begins to Publish (e.g. Endpoint User A's conversation, if any) and Subscribe (to Endpoint Users' B, C, D . . . conversations—each running in real-time on different Channels but on the Network.).

Networks 200 are capable of hosting any number of Channels, with each capable of carrying (XML) Data Streams from a Publishing Endpoint to any number of interested Subscribing Endpoints. Channels carry data snapshots of information observations (in real-time). The source of stream data might originate from e.g. a series of finger powered keystrokes sending text data strings to a chat application or automatically from a temperature, GPS, RFID or other sensor.

In various embodiments, the present invention supports types of data other than audio & video, and the mechanism for describing what is available on a Channel is called a “Channel Guide Schema”, and the mechanism for describing what is available on a Channel's real-time payload is a real-time “Data Schema”.

For example, in one implementation, a Server instance (alone or in conjunction with others) may host a Network 200 with a “temperature” Channel Guide that might declare: “Channel tempSensor_22 is located in the north field. Its make and Model type are: ‘ACME Temperature Sensor’. The sensor's units are in Celsius” as a simple data string. In other implementations, data strings that are not human-readable may also make use of the Channel Guide.

Data (e.g. XML) Formatted Networks

Instant support for heterogeneous Network data formats is provided by the registration of Channel Guide 404 and Data (XML) schemas 402 with a Network 200. The setup of a custom data format for a Network 200 may be effectuated by providing the URIs or Schema files for the two Schemas 402-404. In various embodiments, once a Network 200 is up and running, its Schemas 402-404 remain unchanged. To modify or replace a Schema 202/204, the existing Network 200 is destroyed and a new Network 200 created, with new referenced Schema 202-204.

Once created, upon registration of endpoints with the Service, the Service automatically retrieves referenced Schemas 402-404 from the source location used (typically hosted on a web server) and automatically delivers the Schema 402-404 for use by and at all endpoints participating on the Network 200. This mechanism is used to enable developers to develop and deploy during runtime service without ever needing to ever shut down the system. Accordingly, embodiments of the present invention provide a distributed data distribution service for use over the Internet with support for heterogeneous data formatted Networks 200 (also referred to as Tuple-based data sharing spaces) while retaining the use, but not necessarily the source of Network schemas 402-404 under central administrative control.

Embodiments of the present invention's ability to provide instant (real-time) data distribution services for W3C schemas supports those who wish to use XML standards in the context of flexible and efficient implementation. Typically, Networks would be bound to representative schemas based on schema fragments originating from industry standard schemas such as FpML or emergent standards such as SensorML. The schemas can then be used by a .NET developer to generate .NET classes that may be used to develop Custom Applications on Clients. {FpML=Financial Product Markup Language. SensorML or “Sensor Model Language” is an OpenGIS Technical Specification. It provides UML models and XML-Schema for describing virtually any sensor system, whether in-situ or remote, static or dynamic.}

FIG. 1, Area 4 illustrates a software view of the message stack of a Network 200, in accordance with various embodiments. For the embodiments, various lower level conventional messaging protocols, such as SOAP, TCP/IP, and so forth, are employed.

Organization Information Sharing

In various embodiments, the real-time Agent Networking Service provides automatic information distribution services within a framework of communication simplification. The service is implemented as a loosely coupled service grid that provides information sharing services to organizations that are members of the same service domain. Organizations exert ownership and control over the development, deployment and operation of Client systems (also referred to as Agent Systems) by creating Client systems (also referred to as Agent Systems); creating formatted networks (and referenced schema) that the Client system (also referred to as Agent System) use to communicate with each other; developing and uploading agents for redistribution and registering Server (also referred to as Switch) (organized in Server (also referred to as Switch) pools) to work together as autonomous but co-operative information sharing assets.

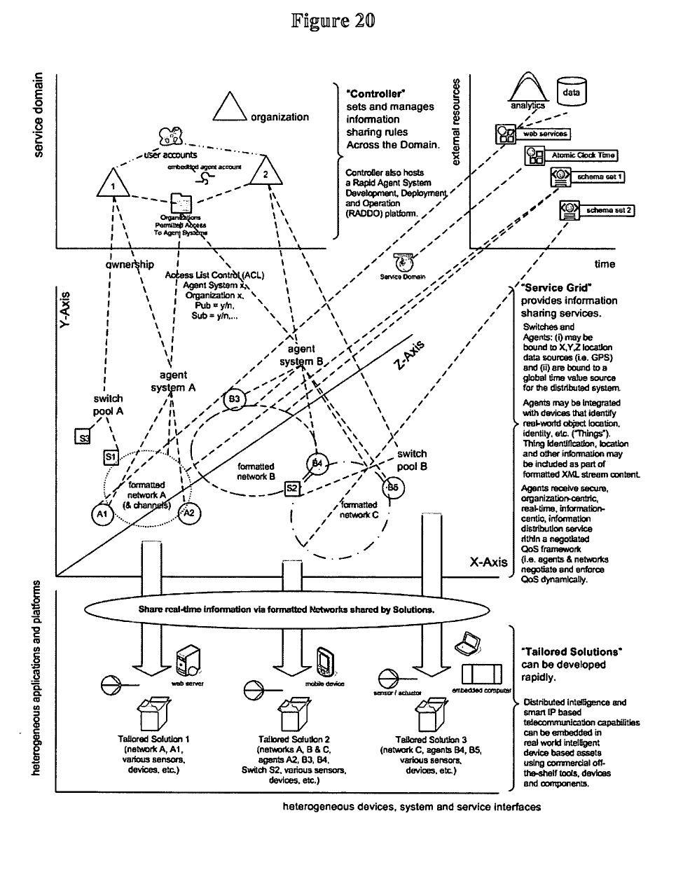

FIG. 20 shows organization 1 as owner of Server (also referred to as Switch) pool A, holding Server (also referred to as Switch) S1 and Server (also referred to as Switch) S3 and owner of Client system (also referred to as Agent System) A, having within it; agent A1, agent A2 and formatted network A. Server (also referred to as Switch) S1 hosts formatted network A. Agent A1 and Agent A2 share information via formatted network A. Agent A1 and agent A2 are also enabled to access a particular external web service, presumably, but not necessarily, with access to the web service arranged by organization 1 or by the developer of Client system (also referred to as Agent System) A. Server (also referred to as Switch) S3 is unused.

Organization 2 owns formatted network C, formatted network B, and owns Server (also referred to as Switch) pool B which holds Server (also referred to as Switch) S2, and owns Client system (also referred to as Agent System) B, having within it; agent B3, agent B4 and agent B5. Server (also referred to as Switch) S2 hosts formatted network A and formatted network B. Agent B4 and Agent B5 share information via formatted network C. Agent B4 and Agent B3 share information via formatted network B.

Formatted network A and formatted network B use schema set 1 (a real-time and channel guide schema pair). Formatted network C uses schema set 2. Network schemas are referenced similarly to how external web services are referenced, presumably, but not necessarily, with access control of schema files managed by an organization owner of the formatted network making use of the schema.

Server (also referred to as Switch) and agents may be bound to fixed or mobile location attributes expressed in various x,y,z formats and when so bound may automatically stamp their respective location attributes into information streams shared via virtual formatted networks that enable agents to telecommunicate over IP networks through firewalls and across the internet.

By using a Management Server web Site service, organization 1 may keep the use of Client system (also referred to as Agent System) A private or may authorize organization 2 to join in the use of Client system (also referred to as Agent System) A with the right to publish and subscribe to, publish only to or subscribe only to formatted network A, if access sharing is enabled but with publish and subscribe access denied the Controller authorizes access to controller resources (downloads, schemas, QoS information, etc.) but denies access to information sharing/distribution services. Similarly organization 2 may share use of Client system (also referred to as Agent System) B with organization 1.

System Model Overview

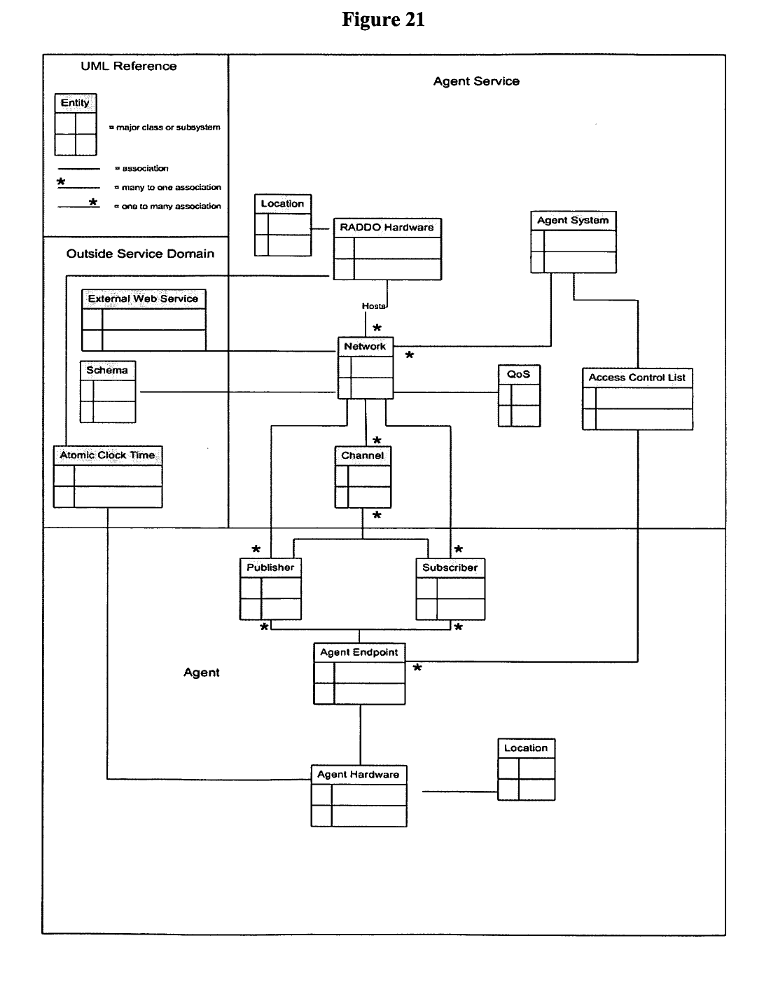

FIG. 21 provides a system object model overview example summary to illustrate various embodiments of the overall system.

Binding Channels to “Points in Space-Time”

In various embodiments, the system uses a referenced external atomic clock web service as its source of time values. Agent Networks can be instructed via the Agent SDK (using TimeStampQoSPolicy) to stamp Channels (carrying XML samples) with time values when sent by an Agent Publisher or with time values when received by the Switch that hosts the Channel. The QoS service can also be instructed via the Agent SDK (using LocationStampQoSPolicy) to optionally stamp Channels with latitude/longitude “location” coordinates using location values that correspond to either Agent location or Switch location. Location latitude and longitude coordinate formats supported include:
DMS (degrees, minutes, seconds) “−93 45 30”
MinDec (decimal minutes) “−93 29.478” or “W93 29.478” or “−93.29.478” or “W93.29.478”
DegDec (decimal degrees) “−93.49130” or “W93.49130”
Custom (such as . . . having 3 arguments) “W 93° 29.478” or “Robson & Cordova”
Proprietary Formats (such as Grid or GIS)

The time and location binding service is independent of the content of Network XML schemas and so provides a universal basis of mapping space and time references onto real-time data distributed by the Server/Switch Grid.

Blinding Channels to Identified Things

In various embodiments, the “AgentSystem” and “NetworkInfo” classes contained in the Agent SDK contain Properties for the referencing of internal and external resources by Agent Systems and by Agent Networks. The Service provides a means of storing external resource web service references to an external XML file or some other external resource capable of being represented by a URI. As an example an Agent System developer may then use a web proxy to an external web service (i.e. that exposes a database or XML file) that would resolve identities on record that correspond to uniquely identifiable electronically sensed “things”. Since it is impractical to tag all of the world's “things” and expect one database to resolve so many identities but for those “things” that can be sensed (and a unique identifier returned) and that are database listed, some of the identities can be resolved, and for those not capable of being resolved, they could be simply ignored or reported as such. (Note: Web Proxies are auto generated using a Microsoft Visual Studio tool. A Web Proxy is a client object interface capable of consuming custom Web Services.) As an additional example, a RFID tag reader could be integrated with the Service using the Agent SDK. A database could be securely accessed via web services from an Agent and using the Agent SDK then resolve the RFID tag values read versus identity relationships stored in the database. By using developer supplied logic, an Client Application or Agent could be made to accept RFID tags once read by an integrated RFID reader and then make a secure web service call to the external database to obtain information about the “thing” that has been RFID tagged. The value added information retrieved could then be bound into the Publisher's message stream at the Agent that sensed the “thing”. At the same time, the Network QoS might be set to stamp Agent location onto the Channel that was used to identify the “thing”. Consider four approaches to real-time remote observation:
A Channel may be used to bind to a fixed location (i.e. RFID tag sensing) identity sensing device, such as for example, at a retail store check out counter. The tags on “things” would be read and tag values resolved to assemble useful identification and other information and then bound into the real-time Channel stream that is itself bound to a fixed location and then published live over the Service.
A Channel may be used to bind to a mobile location based identity sensing device, such as for example, on a truck. The tags on “things” would be read and tag values resolved to assemble useful identification and other information and then bound into the real-time Channel stream that is itself bound to a dynamically updating location of the vehicle using, for example, GPS and then published live over the Service.
A Channel may be used to bind to an observed or identified (sensed) “thing” such as physical things that would be identified by a radio identification beacon or by a RFID tag that would be attached to a shipping container loaded on a truck trailer, for example. The tags of the “things” read (sensed) and then resolved would use the Service to assemble useful identification and other information attributable to the identified “thing” and then bind this value-added information into the real-time Channel stream that is itself bound to fixed location coordinate values and then published live over the Service.
Similar to the third method but where the Channel used for the identified “thing” would be bound to a location that may be dynamically updated using a mobile remote sensing presence. For example, a moving truck or flying helicopter reading RFID tags on tagged “things” distributed in open areas.

Managing Network QoS

In various embodiments, the Real-Time Service uses a non protocol bound, orchestrated web service based communication model that ‘simulates’ real-time communications using web service messages. The Internet side, or external side of the communication service exposes web service based communication interfaces to Service Agent applications. Such applications may contain instances of Publisher objects and instances of Subscriber objects. In various embodiments, the internal (Real-Time Server) side of the communication service may communicate via a WSE 2.0 to NET 1.1 bridge facility that operates in concert with QoS, XML stream routing and other service facilities that operate under the control of the Real-Time Server Engine. In various embodiments, the process of managing Network QoS from the Service side involves the use of a software engine that creates, maintains and destroys a Network QoS Sub-Engine (also referred to as the Formatted Network Message Orchestration Service 107) for each Network requested (on-demand) and creates, maintains and destroys a Publisher QoS Sub-Engine for each Publisher object instance requested by an Agent and creates, maintains and destroys a Subscriber QoS Sub-Engine for each Subscriber object instance requested by an Agent. Network QoS Sub-Engine instances, Publisher QoS Sub-Engine instances and Subscriber QoS Sub-Engine instances are all instantiated on the Real-Time Server. Each of the Network QoS Sub-Engine, the Publisher QoS Sub-Engine and the Subscriber QoS Sub-Engine has a separate implementation and thus each engine may customized at design time to implement certain QoS policy logic necessary to meet specific requirements, thus the QoS model is the Real-Time Server is extensible. For the purposes of illustration of embodiments, some QoS policy examples may be based or derived from QoS policies pertaining to custom or published standards for the networking of clients and servers.

Thus, the QoS Extensible design of the Real-Time Server is a superior model in that (i) custom Servers may be developed to meet specific application requirements or (ii) existing Server model releases may be evolved over time to offer a richer scope of QoS Policy support for QoS of Communication (clocked service behavior), QoS of Data Routing (order, flow and rules of distribution) and QoS of Data Production (content stamping, signing, etc.).

For any embodiments, a Network's QoS policies are set upon creation of a Network. For any embodiments, some QoS policies may be negotiable between the specific host Network and Publisher or Subscriber (objects) that access a Network. For embodiments, compatibility of QoS Policy settings at each endpoint may be subject to the high water mark set for a QoS on a Network. Thus, for any embodiment, within this framework of negotiation and enforcement, the Service automatically may apply QoS (Quality of Service) at all points of the data distribution process such that a process of QoS policy negotiation, if required, may involve Network, Publisher or Subscriber entities and if the policy applies to only one entity, for example policy applies to Network or policy applies to Publisher or policy applies to Subscriber then the QoS policy is enforced and not negotiable. Thus, for various embodiments, a QoS policy that involves Network and Publisher; or Network and Subscriber; or Network and Publisher and Subscriber, operates within the framework of negotiation and enforcement, supported by distributed dynamic Network Service Contract 102 enforcement processes to control and authorize heterogeneous information sharing, heterogeneous device sharing and heterogeneous application sharing as supported by collective embodiments of the distributed integrated systems of the Management Server 100, Networked Client Applications 104, Network Server Applications 103, Formatted Network Message Orchestration Service 107 and the use of the Message Stack (Area 4 of FIG. 1).

Thus in various embodiments, the application of QoS policy is dynamic within a mechanism of distributed real-time negotiation (explained in the QoS Policy Negotiation Example).

In various embodiments, one or more of the following QoS policies are supported. For the purposes of illustration of QoS policy examples, examples have been based on the DCPS/PIM section of the OMG Adopted Specification entitled Data Distribution Service for Real-Time Systems Specification (also known as DDS) dated May 2003. For any embodiments there is no particular requirement that any part of the DDS QoS model be used because the system is designed to accommodate the implementation of custom QoS policy logic to meet specific data distribution requirements. Thus, for the purposes of illustrating the embodiments, examples of such QoS policies may include but are not restricted to ReliabilityQoSPolicy, CacheQoSPolicy and others. In any embodiments, as the following QoS implementation example illustrates, specifically for example, the LocationStampQoSPolicy which is not included in DDS, and other QoS policies although similar at an abstract level to DDS QoS are implemented for the example in ways not covered by DDS, the system is designed to accommodate the implementation of custom QoS policy logic to meet specific data distribution requirements. Refer to the “Binding Channels to “Points in Space-Time” topic and “Binding Channels to Identified Things” topic for other examples.

TABLE 1
QoS Implementation Example - In various embodiments, QoS Policies
include:

| | Objects | | |
|---|---|---|---|
| QoS Policy | Concerned | Set By | Negotiable By |
| CacheQosPolicy | Publisher | Publisher | Negotiable by |
| | | | Publisher |
| DeadlineQoSPolicy | Network, | Network | Negotiable by |
| | Publisher, | | Publisher |
| | Subscriber | | |
| DestinationOrderQoSPolicy | Network, | Network | Not Negotiable |
| | Subscriber | | |
| HistoryQoSPolicy | Network, | Network | Negotiable by |
| | Publisher, | | Subscriber |
| | Subscriber | | |
| LatencyBudgetQosPolicy | Network, | Network | Not Negotiable |
| | Publisher, | | |
| | Subscriber | | |
| LivelinessQosPolicy | Network, | Network | Negotiable by |
| | Publisher, | | Publisher |
| | Subscriber | | |
| LocationStampQosPolicy | Concerns | Network | Not Negotiable |
| | Network, | | |
| | Publisher | | |
| OwnershipQosPolicy | Network, | Network | Not Negotiable |
| | Publisher | | |
| CoherentQosPolicy | Network, | Network | Negotiable by |
| | Publisher, | | Publisher, |
| | Subscriber | | Negotiable by |
| | | | Subscriber |
| ReliabilityQosPolicy | Network, | Network | Negotiable by |
| | Publisher, | | Subscriber |
| | Subscriber | | |
| TimeBasedFilterQosPolicy | Subscriber | Subscriber | Negotiable by |
| | | | Subscriber |
| TimeStampQosPolicy | Network, | Network | Not Negotiable |
| | Publisher | | |

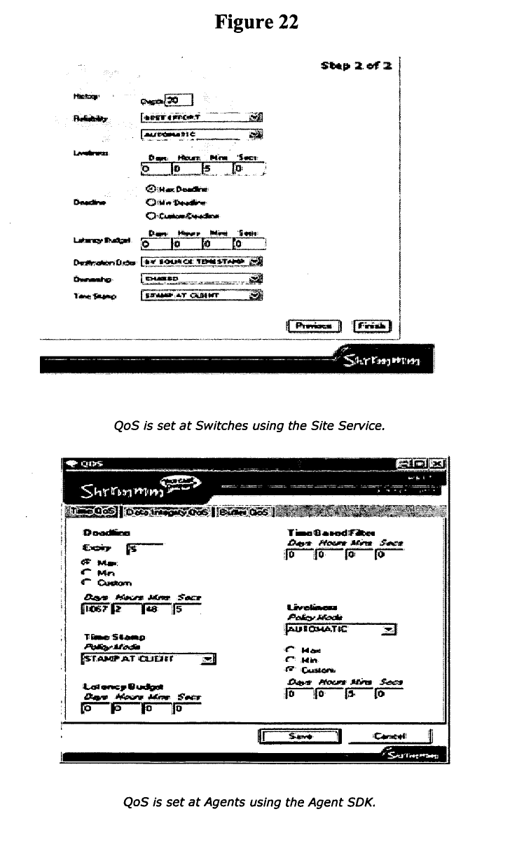

FIG. 22 illustrates various embodiments of the dynamic QoS policy mechanism of distributed orchestrated QoS policy negotiation with user interface examples.

For a description of the illustrated custom QoS policies refer to the Agent Base, SDK and UI Modules Example topic. Agent Base, SDK and UI Modules Example

In various embodiments, the following Client/Agent side Modules are supported. The following example Agent class library documentation illustrates.

Agent Base Module

Agent.Base Namespace

Contains a common object dictionary used across the Service Domain.

Classes

Class Description

ReturnCode

Enumerations

Enumeration Description

CallStatus Indicates the end result status of an outgoing call.

ServiceProtocols Protocols indicate which protocols are supported by specific Switches.

Agent.Base.AgentSystems Namespace

Classes that contain information about Agent Systems and Agent Networks.

Classes

Class Description

Agent_System_Info An Agent System consists of one or more Networks, and one or more deployments of Business Agent apps and/or Embedded Agent apps. All Networks/Agent Apps in an Agent System have the same security lists. Networks that are shared in more than one Agent System (configured through the RADDO site) inherit from both access lists.

Network_Info Network_Info contains all the information about a Network to connect and use it from the Agent SDK. This includes Switch connection information, Publish/Subscribe rights to the Network and more. The schemas in this object must be ‘compiled’ before they can be used to validate data in an Agent application(using Publisher or Subscriber).

Agent.Base.Data Namespace

Contains object definitions that are used to Publish, Subscribe and recieve state information about real time streams of data.

Classes

Class Description

Channel_Guide_Data Channel_Guide_Data is sent to Subscribers whenever a new Channel appears in a Network. Channel_Guide_Data contains guide which is an XML document that must conform to the Networks Channel Guide Data schema as registered on the RADDO site. It also contains a handle used to uniquely identify the Channel.

Channel_Identifier Channel_Identifier is used to uniquely identify channels from one another. Every Channel_Identifier within a given Network must be unique whether custom, or system generated (a Guid).

Data_Sample A Data_Sample represents an atom of data information (i.e., one value for one Channel at a given point in space and time) as returned by Subscriber's On_New_Data event. It consists of two parts: A Sample_Info and the Data. It is delivered to Subscriber by the on_data_available event.

Real_Time_Data Real Time Data is a class used by Publisher and Subscriber to attach payload data coming from a source such as a sensor, to an Channel_Identifier. The XML data must conform to the Real Time Data schema as defined by the Network.

Sample_Info Sample_Info is the information that accompanies each sample that is ‘Subscribed’. It contains information about the state of data, where it is from and what time is was Published.

Agent. Base.Misc Namespace

Contains parts that are not necessary but may be useful in building an Agent application.

Classes

Class Description

XTimer A Timer that can be set to raise an event with an id on its elapsed event. This class is not needed to use the Agent system and is provided for your convenience. It is accurate to 1 second.

Delegates

Delegate Description

XTimer.dObject

Agent.Base.Physics Namespace

Classes that represent measurements of the spatial dimensions (x,y,z) and time.

Classes

Class Description

Duration Represents a duration of time. The TimeSpan property is Value

Location A class for Spatial measurements.

Time Like DateTime but with a method that will set time more precisely. The DateTime property is Value

Enumerations

Enumeration Description

Coordinate_Format 3 standard formats of Lat/Long Coordinates. Also a custom format enumeration.

Agent.Base.QOS.Entities Namespace

Publishers and Subscribers share QoS with their Network. They share some common QoS Policies, and some Policies are specific to them. This Namespace packages these policies up for use.

Classes

Class Description

PublisherQos PublisherQos is a set of policies that apply to a Publisher. These policies are negotiated with the Network (i.e. “chat Room network”) and if deemed compatible, they establish a contract of behavior that the Publisher must adhere to once enabled. Some of this behaviour is automatic(liveliness), some is not(deadline) and some serves as a reference as to how the Network will behave once the data is published.

SubscriberQos SubscriberQos is a set of policies that apply to a Subscriber.

These policies are negotiated with the Network(i.e. “chat Room”) and if deemed compatible, they establish a contract of behaviour that the Subscriber must adhere to once enabled. Some of these policies(liveliness, deadline) are a reference as to how the Network will behave when Published data is pushed through it. Some policies(TimeBasedFilter, History, reliability) tune the Network to deliver data the way the individual Subscriber wants it.

Agent Base QoS Policies Namespace

The atomic individual QoS policies.

Classes

Class Description

CacheQosPolicy CacheQosPolicy—manages XML burst writes. The QoS policy only applies to Publishers. The policy manages automatic burst writes to and operates in three modes. If the CacheQosPolicy setting is NONE, then the Publisher does not use a cache. All writes to the service are performed independently. If set to TIMER, the cache will flush written samples at least every max_time_limit. If set to SAMPLE_COUNT, the cache will flush written samples once the total number of samples written exceeds max_sample_limit. The policy runs locally on a Agent Network endpoint Agent Runtime and does not require negotiation. It may also violate other policies contracts with the Agent Network service such as Deadline and Liveliness.

CoherentQosPolicy CoherentQosPolicy—manages how different Channel samples that may be dependent upon each other are propagated. Specifies how the samples representing changes to Channel samples are presented to the subscribing Agent Runtime. The policy affects the Agent Runtime's ability to: specify and receive coherent changes see the relative order of changes. The maximum scope of entities for which the order and coherency of changes can be preserved is determined by access_scope. The QoS policy controls the extent to which changes to Channel samples can be made dependent upon each other and the kind of dependencies that may be propagated and maintained. The granularity is controlled by the setting of the access_scope. • If access_scope is set to INSTANCE, the use of begin_coherent_change and end_coherent_change has no effect on how the subscriber can access the data because with the scope limited to each instance, changes to separate instances are considered independent and thus cannot be grouped by a coherent change. • If access_scope is set to Network, then coherent changes (indicated by their enclosure within calls to begin_coherent_change and end_coherent_change) will be made available as such to each remote Subscriber independently. That is, changes made to instances within the each individual Publisher will be available as coherent with respect to other changes to instances in that same Publisher, but will not be grouped with changes made to instances belonging to a different Publisher. • If access_scope is set to GROUP, then coherent changes made to instances through a Publisher attached to a common PublisherManager are made available as a unit to remote subscribers. If ordered_access is set, then the access_scope controls the maximum extent for which order will be preserved • If access_scope is set to INSTANCE (the lowest level), then changes to each instance are considered unordered relative to changes to any other instance. That means that changes (creations, deletions, modifications) made to two instances are not necessarily seen in the order they occur. This is the case even if it is the same application thread making the changes using the same Publisher. • If access_scope is set to Network, changes (creations, deletions, modifications) made by a single Publisher are made available to subscribers in the same order they occur.

Changes made to instances though different Publisher entities are not necessarily seen in the order they occur. This is the case, even if the changes are made by a single application thread using Publisher objects attached to the same ABasePublisher. • Finally, if access_scope is set to GROUP, changes made to instances via Publisher entities attached to the same Publisher object are made available to subscribers on the same order they occur.

DeadlineQosPolicy DeadlineQosPolicy—manages the deadline time period for XML instance updates. Presumes (i) a Subscriber expects a new sample updating the value of each instance at least once every deadline_period and (ii) a Publisher indicates that the Agent Runtime commits to write a new value (using the Publisher) for each instance managed by the Publisher at least once every deadline_period and (iii) the default value of the deadline_period is 5 minutes. The policy is useful for cases where a Agent Network is expected to have each instance updated periodically. On the publishing side the setting establishes a contract that the Agent Runtime must meet. On the subscribing side the setting establishes a minimum requirement for the remote Publisher that is expected to supply the data values. When a Publisher or Subscriber connects to the Agent Network, it checks whether the settings are compatible with the Agent Network's (i.e., offered deadline less than or equal to requested deadline). Assuming that the Agent Network Engine Endpoints have compatible settings, the fulfillment of the contract is monitored and the Agent Runtime is informed of any violations by means of the proper listener.

The value offered is considered compatible with the value requested if and only if the inequality “offered period less than or equal to requested period” evaluates to ‘TRUE’. The policy does not factor in variables such as Internet latency or processing time. This policy is useful for cases where a Network is expected to have each Channel updated periodically. On the publishing side this setting establishes a contract that the application must meet. On the subscribing side the setting establishes a minimum requirement for the remote Publishers that are expected to supply the data values. Assuming that the reader and writer ends have compatible settings, the fulfillment of this contract is monitored and the application is informed of any violations.

The value offered is considered compatible with the value requested if and only if the inequality offered period LESS THAN requested period evaluates to TRUE.

DestinationOrderQosPolicy DestinationOrderQosPolicy—manages order reAgent_System_Info of XML Channels subscribed where multiple publishers are used. Controls criteria used to determine the logical order among changes made by Publishers to the same Channel sample. The policy controls how each Subscriber resolves the final value of a Channel sample that is written by multiple Publisher objects (which may be associated with different Publisher objects) running on different nodes with different local times. The setting BY_RECEPTION_TIMESTAMP indicates that the latest received value for the Channel should be the one whose value is kept. This is the default value. The setting BY_SOURCE_TIMESTAMP indicates that a timestamp placed at the source should be used. This is the only setting that, in the case of concurrent Publisher objects updating the same Channel, ensures all Subscribers will end up with the same final value for the Channel.

HistoryQosPolicy HistoryQosPolicy—manages the number of XML Channels to be kept in cache to accommodate subscribers taking up data at different rates. The HistoryQoSPolicy allows the specification of a number of samples to be kept in the cache in support of situations where Subscribers may consume data samples at different rates. The policy, in conjunction with ReliabilityQosPolicy, controls whether the Network should deliver only the most recent value, all values or a scope of values that the Service has the present capacity to deliver.

LatencyBudgetQosPolicy LatencyBudgetQosPolicy—provides guidance as to the maximum acceptable delay between receipt of published Channels to the automatic propagation of XML samples to subscribers. Provides guidance as to the maximum acceptable delay from the time the data is written to the Agent Network, to the time it is received by the subscribing Agent Runtimes. The policy is informative to the Service, not something that must be monitored or enforced. The Service is not required to track or alert the user of any violation. The default value of the duration is zero indicating that the delay should be minimized. The policy provides a means for the Agent Runtime to indicate to the Network the “urgency” of information communication. By having a non-zero duration, the Agent Network can optimize its internal operation. The policy provides the Service a hint and will not cause the Service to fail to match Agent Network Engine endpoints due to incompatibility of QoS but rather will automatically adapt behavior on the publishing end to meet requirements of individual subscribers. Consequently QoS will never trigger an incompatible QoS notification, nor have any listeners associated with violations of the contract. The value offered to the Agent Network is considered compatible with the value requested by Subscriber or Publisher if and only if the inequality “offered duration less than or equal to requested duration” evaluates to ‘TRUE’.

LivelinessQosPolicy Determines the mechanism and parameters used by the application to determine whether an Entity is “active” (alive). The “liveliness” status of an Entity is used to maintain instance ownership in combination with the setting of the OWNERSHIP QoS policy. The application is also informed via listener when an Entity is no longer alive. The Subscriber requests that liveliness of the writers is maintained by the requested means and loss of liveliness is detected with delay not to exceed the lease_duration. The Publisher commits to signaling its liveliness using the stated means at intervals not to exceed the lease_duration. Events are used to notify the Subscriber of loss of liveliness and Publisher of violations to the liveliness contract. The default kind is AUTOMATIC and the default value of the lease_duration is infinite. This policy controls the mechanism and parameters used by the Network to ensure that Publishers on the Network are still “alive”. This policy has several settings to support both data-objects that are updated periodically as well as those that are changed sporadically. It also allows customizing for different application requirements in terms of the kinds of failures that will be detected by the liveliness mechanism. The AUTOMATIC liveliness setting is most appropriate for applications that only need to detect failures at the process-level, but not application-logic failures within a process.

The Network takes responsibility for renewing the leases at the required rates and thus, as long as the local process where a AgentEndpoint is running and the link connecting it to remote participants remains connected, the entities within the AgentEndpoint will be considered alive.

LocationStampQosPolicy LocationStampQosPolicy—to stamp location (x,y,z) co-ordinates of Channels using the location co-ordinates of the Publisher instance (in an Application or Smart Agent) or the location of the Switch hosting the Agent Network. Used to instruct the Network where the LocationStamp of a Real_Time_Data Sample is to be set. The default setting is STAMP_AT_CLIENT. The format of the LocationStamp is presumed to be the client's (Agent Runtime) responsibility when STAMP_AT_CLIENT is set. When STAMP_AT_SWITCH is used, the stamped value will contain the latitude, longitude and elevation (GPS) coordinates of the Switch responsible for hosting the Agent Network.

OwnershipQosPolicy OwnershipQosPolicy—enables Agent Network communication Channels to be reserved for exclusive “publisher” use by the Account owner(or Smart Agent account) or shared by a list of authorized Accounts. The policy only applies to Network and is not negotiable to Publishers because it would make no sense for a Publisher to override the setting in the Agent Network. There are two kinds of OWNERSHIP: SHARED and EXCLUSIVE. Networks that have OwnershipQosPolicy set to SHARED allow Channels to be “published” to by any Account (with publish access to the Agent Network enabled). Agent Networks set to EXCLUSIVE only allow the accounts that created the channels to write to, and destroy them. The policy survives sessions, meaning that a Publisher acting under the account “Joe of Organization A” that has created a Channel, may be accessing the Agent Network some time after disconnecting, and resume publishing to that specific Channel, confident that the last value written to that Channel was from the “Joe of Organization A” Account.

ReliabilityQosPolicy See ReliabilityQoS Policy members below:

TimeBasedFilterQosPolicy TimeBasedFilterQosPolicy—enables a Subscriber to receive Channels delivered on a Agent Network every specified time interval instead of receiving all Channel samples.

Allows a Subscriber to specify that it is exclusively interested in (potentially) a subset of data Samples. The filter states that the Subscriber does not want to receive more than one value each minimum_separation, regardless of how fast the changes occur. The setting of the QoS policy is incompatible with RELIABILITY policy set to ALL. By default minimum_separation=0 indicating a Subscriber is potentially interested in all values. The policy allows a Subscriber to indicate that it does not want to receive all values of each Channel published under the Agent Network but rather wishes to receive at most one change every minimum_separation period. The setting allows a Subscriber to further de-couple itself from the Publisher objects. It can be used to protect Agent Runtimes that are running on a heterogeneous network where some nodes are capable of generating data much faster than others can consume it. It also accommodates the fact that for fast-changing data different subscribers may have different requirements as to how frequently they need to be notified of the most current values.

TimeStampQosPolicy TimeStampQoSPolicy—Controls where the stamping of occurs, either by system wide atomic clock time onto Channels when written by the Publisher or when received by the Agent Network from the Publisher. This policy enforces a consistent methodology of stamping time on data Samples. In a distributed real-time system, Switches (in Pools) and Agent Runtimes (at endpoints) may have out-of-sync clocks which can produce conflicting time values. Use of the policy controls a mechanism that produces consistent time stamps on data samples across space. The default setting is STAMP_AT_CLIENT, which causes the system clock of the Agent Runtime host computer to generate a TimeStamp value if no TimeStamp is written with the sample by the Publisher. The STAMP_AT_SERVER setting discards, upon arrival of data samples, all TimeStamps received by the Agent Network from endpoint Agent Runtimes and stamps data samples with a TimeStamp generated by the system clock for the Agent Network responsible for hosting the Agent Network being published to. Switch clocks are synchronized using an atomic clock web service on the Internet. This policy does not factor in variables such as Internet latency.

Enumerations

Enumeration Description

CacheQosKind Controls the trigger type of the caching mechanism used by the Publisher.

CoherentScopeQosKind Controls the scope of coherent change sets written by Publishers. Entering a Coherent Change set is done by use of Publisher Managers

DestinationOrderQosKind Controls how Subscribers order the Data Samples upon reception

LifecycleStateKind The 4 possible states a Data Sample can be in.

LivelinessQosKind LivelinessQosPolicy—manages the process of verification of the presence of communication transport and the issuance of alerts in the event of communication failure. Determines the mechanism and parameters used by the Agent Runtime to determine whether an Entity is “active” (alive). The Agent Runtime is also informed via a event when an Entity is no longer alive. Presumes Subscriber requests that liveliness of the Publishers is maintained by the requested means and that loss of liveliness is detected with delay not to exceed the lease_duration interval. The Publisher commits to signaling its liveliness using the stated means at intervals not to exceed the lease_duration. Events are used to notify the Subscriber of loss of liveliness and Publisher of violations to the liveliness contract. The default kind is AUTOMATIC.

The policy has several settings to support both data-objects that are updated periodically as well as those that are changed sporadically. It also allows customizing for different application requirements in terms of the kinds of failures that will be detected by the liveliness mechanism. The AUTOMATIC liveliness setting is default. The Agent Runtime takes responsibility for renewing the leases at the required rates and thus, as long as the local process where an Endpoint Agent Runtime hosted object is running and the link connecting it to the Agent Network remains connected, the objects within the Endpoint Agent Runtime will be considered alive. This requires the lowest overhead. The MANUAL setting requires the Agent Runtime on the publishing side to periodically assert the liveliness before the lease expires to indicate the corresponding Entity is still alive. The action can be explicit by calling the assert_liveliness operation, or implicit by writing some data at least every lease_duration. The policy does not factor in variables such as Internet latency or code execution time.

OwnershipQosKind Shared means the channel will be shared in the Network (i.e. any account can publish to it). Exclusive means the channel is locked to the account that ‘registered’ it.

ReliabilityQosKind Indicates the level of reliability offered by the Network.

SampleStateKind The when subscribing, data samples are ‘subscribed’ to when they match the SampleStateKind set at the Subscriber.

StampQosKind Controls whether the stamp is set at Client or Switch

ReliabilityQosPolicy Members

Public Static (Shared) Methods

Equals (inherited from Object) Determines whether the specified Object instances are considered equal.

ReferenceEquals (inherited from Determines whether the specified Object instances are

Object) the same instance.

Public Instance Constructors

ReliabilityQosPolicy Constructor

Public Instance Fields kind

Public Instance Methods

Equals (inherited from Object) Determines whether the specified Object is equal to the current Object.

GetHashCode (inherited from Serves as a hash function for a particular type, suitable

Object) for use in hashing algorithms and data structures like a hash table.

GetType (inherited from Object) Gets the Type of the current instance.

ToString (inherited from Object) Returns a String that represents the current Object.

Agent.Base.STATUS Namespace

All Status Classes. Status classes are used to rely state information that is sent in events raised by Publishers and Subscribers.

Classes

Class Description

DeadlineMissedStatus Information about the Deadline missed event.

LivelinessLostStatus Information about the Liveliness Changed event.

Status Status is the abstract root class for all communication status objects. All concrete kinds of Status classes specialist this class.

Agent SDK Module

The Agent SDK module contains classes to authenticate with a RADDO Appliance (or farm), discover Agent Systems and create Publishers, Subscribers. The following classes are used.

AgentEndpoint Namespace

The Agent SDK AgentEndpoint namespace contains the AgentEndpoint class and the following delegates:
AgentEndpoint.don_ping

AgentEndpoint

The AgentEndpoint object provides a mechanism to pass Agent credentials from the Agent Runtime to the RADDO service through the “set_credentials” method. The RADDO Platform checks whether an Account is in good standing. The AgentEndpoint object also provides the Agent Runtime with a facility to find available Agent Networks through the operation “discover_agent_systems”. AgentEndpoint provides facilities to create and bind Publishers and Subscribers to Networks. AgentEndpoint manages Internet communications and provides a facility to create or find and reconnect lost or broken Publishers or Subscribers. AgentEndpoint also returns total bandwidth used when accessing the service and can reset a “session”.

The Agent SDK Publish namespace contains the Publisher class and the following delegates:
Publisher.dChannelGuideDataValidationError;
Publisher.don_liveliness_lost;
Publisher.don_offered_deadline_missed;
Publisher.dRealTimeDataValidationError.

As an illustration of implementation, the AgentEndpoint members are as follows:

Public Static (Shared) Fields

internetLatency Internet Latency is used to determine how much time to give the client SDK to signal Liveliness and other time dependant messages. If liveliness was set to be signaled every 5 minutes, and internetLatency was set at 7 seconds, Liveliness would be signaled every 4 mins, 53 secs(plus processing time and code execution).

Public Static (Shared) Properties

enabled Indicates whether the Runtime has credentials and is able to create and host Publisher and Subscriber Objects.

protocol This sets the Protocol used to connect to Networks and therefore Switches.
This is the Master Appliance address. The default value is

ServiceDomain “http://www.Thingtel.net” and points to the Thingtel Demo RADDO Appliance. This must be changed to your appliances domain name/IP address.

username The Agent account that is requesting or using the service.

Can be Business Agent Account or Embedded Account.

This property is set automatically using Set_Credentials( . . . )

Public Static (Shared) Methods

AuthenticateAndCheckVersion Authenticates your account to use the service. Also checks the current version of the RADDO platform; if the platforms version is different than the SDK then a message will be returned by versionMessage. If versionMessage is null, then the versions are up to date.

call_ping Ping a specific Switch. Switches can be discovered in Network_Info objects when discover_agent_systems( ) is called.

ClearCredentials removes credentials set by Set_Credentials from the runtime

create_ublisher Creates a Publisher object bound to an Agent Network

create_subscriber Creates a Subscriber object bound to a Agent Network.

delete_ublisher

delete_subscriber

discover_agent_systems After credentials are set, you may download a list of Agent_System_Infos(containing Networks) that your account is granted access for.

Equals (inherited from Object) Determines whether the specified Object instances are considered equal.

Initialize_Agent_System_Info_Initializes connections to any Switches that are hosting

Connections Networks belonging to a particular Agent System. Call this with the Agent_System_Info you intend to connect to. This is not necessary but speeds up code execution later. Also this will establish connections to any Switches that are hosting Networks in the Agent_System_Info.

Kill_Runtime Optionally the last call to the Agent SDK once an Agent Application shuts down. This method will take a duration and start a new thread that waits the duration and then kills the entire Process(and AppDomain).

PingSwitches This method forces any Switches you are connected to(through Publishers/Subscribers bound to Networks) to fire a Ping to the clients custom Ping Interface. This proves that the eventing system is in good health.

ReferenceEquals (inherited Determines whether the specified Object instances are the from Object) same instance.

ResetSession This is to be the last call to the service to give it a hint that it should consider resetting the session early(and thus all Publishers and Subscribers). Once called, if the Agent Application wants to reconnect, it must create new Pubs/Subs again but can reuse everything else.

SetCredentials This is the first call that should be made in this SDK. It must be a valid Embedded/Business Agent account, if Business Agent, remember to enable ‘Real Time’ access using by the RADDO/Business Agent Accounts page.

StartEventListeners This method must be called to begin ‘listening’ for events and real time data from the service.

StopEventListeners Should be called to stop ‘listening’ for events and data samples from the service.

Public Static (Shared) Events

On_Ping Fires when Switches Ping the client. Since there can be many Networks hosted on one or more Switches, you may receive multiple Pings from Switches you are connected too. Pings are used to test the RADDO eventing mechanism and are initiated by the AgentEndpoint.ping_switches( ) method.

Public Instance Constructors

AgentEndpoint Constructor

Public Instance Methods

Equals (inherited from Object) Determines whether the specified Object is equal to the current Object.

GetHashCode (inherited from Serves as a hash function for a particular type, suitable Object) for use in hashing algorithms and data structures like a hash table.

GetType (inherited from Gets the Type of the current instance.

Object)

ToString (inherited from Returns a String that represents the current Object.

Object)

Publisher Namespace

Publisher

Publisher objects are bound to a specific Agent Network for the entirety of their life. Publisher includes QoS policies that describe how the Publisher must behave once “enabled”. Some of these policies are automatically handled by the Publisher (Liveliness, LatencyBudget . . . ), (Liveliness is implemented using delegates) some are handled implicitly by writing data through Channels to the Network (Deadline, . . . implemented using delegates), and others are handled by the Network and serve as a kind of contract between your Publisher and that specific Network. Publisher objects also have a CacheQosPolicy which controls automatic burst writes to the Network without user intervention. Publisher objects provide read-only access to automatically compiled schema that correspond to the type of Agent Network such that a temperature Publisher object would have a ‘Real-Time format’ temperature schema, and a ‘Channel-Guide format’ context schema. Publishers also provide a facility to register, un-register and lookup Channels. Publisher objects enable information to be written to an Agent Network providing the information being written conforms to the Real-Time schema. Thus Publisher uses a data validation process, implemented using delegates, that can check all data being published to ensure it meets the Network's schema requirements.

As an illustration of implementation, the Publisher members are as follows:

Public Static (Shared) Properties

DefaultTimeout (inherited from the web service middleware such as

Microsoft.Web.Services2.Messaging.SoapClient)

Public Static (Shared) Methods

Equals (inherited from Object) Determines whether the specified Object instances are considered equal.

ReferenceEquals (inherited from Object) Determines whether the specified Object instances are the same instance.

Public Instance Fields

enabled (inherited from

Agent.SDK.Private.wseClientBase)

ValidateChannelGuideData Turns Channel Guide Data Validation On/Off

ValidateRealTimeData Turns Real Time Data Validation On/Off

Public Instance Properties

Channel (inherited from the web service middleware

Microsoft.Web.Services2.Messaging.SoapSender)

Destination (inherited from the web service

middleware

Microsoft.Web.Services2.Messaging.SoapSender)

dp (inherited from

Agent.SDKPrivate.wseClientBase)

instance (inherited from

Agent.SDK.Private.wseClientBase)

level

network the Network_Info object that corresponds to the Agent Network that this Publisher is bound to

Pipeline (inherited from the web service middleware

Microsoft.Web.Services2.Messaging.SoapPort)

qos The Quality of Service settings of this Publisher

Timeout (inherited from the web service

middleware

Microsoft.Web.Services2.Messaging.SoapClient)

Public Instance Methods

assert_liveliness This method is called to tell concerned Networks that this AgentEndpoint is still operational. All other methods in Publisher implicitly assert liveliness. This is used if you have Liveliness QoS set to manual, and the sole operation is to assert your ‘Publishers’ Liveliness

AutoGetQos Sets the Networks QoS automatically. This represents the highest level of Qos that the Network Supports. If autoSetQos is set to true, the Publishers QoS is automatically set to the Networks default. This does not require a returnCode as the Networks QoS cannot be incompatible with itself.

begin_caching This method is used in conjunction with CacheQoSPolicy. It is used to control burst writes in Agent Applications that may produce data samples faster than the RADDO platform can handle. This method enables data samples to be written in bursts, saving bandwidth and computing power. It only applies to samples by this Publisher.

begin_coherent_changes This can be used to mark samples written as a set and delivered as a set. Every time this method is called without calling its corresponding ‘end_coherent_changes’ method, it goes up a level. So multiple sets can be formed at once. Sets can even span multiple Networks if the QoSCoherencyScope is set to GROUP.

BeginSend (inherited from the web service middleware

Microsoft.Web.Services2.Messaging.SoapSender)

enable This is called after the object has been set up with QOS, events have been hooked up to. This must be called before any publishing of data, or registering channels.

end_caching This method will flush all samples written in the cache (since begin_caching was called) to the Network. Any data written after the flush is done will be cached until next end_cache is called, or a threshold in cache qos is hit, or resume publication is called.

EndSend (inherited from the web service middleware

Microsoft.Web.Services2.Messaging.SoapSender)

Equals (inherited from Object) Determines whether the specified Object is equal to the current Object.

GetHashCode (inherited from Serves as a hash function for a particular type, suitable

Object) for use in hashing algorithms and data structures like a hash table.

GetType (inherited from Gets the Type of the current instance.

Object)

lookup_channel This looks up a Channel and indicates whether the Channel exists(true) or does not exist(false).

register_channel Overloaded.

register_channel_with_custom_Overloaded. Attempts registration of a

handle Channel_Identifier that has a custom value. This is useful for such ID schemes as RFID, UPCs, or even ‘IM buddy names’, where a Channel ID would be ‘jordan’ or ‘Dave’. Jordan would chat on his channel and Dave on his. Also does Channel Guide/Real Time XML schema validation, any invalid XML fires a Validation Error event.

Send (inherited from the web service middleware

Microsoft.Web.Services2.Messaging.SoapSender)

SetQos Sets the Qos with manually, this QoS must be compatible with the Networks QoS which can be retrieved by AutoGetQos(false)

ToString (inherited from Returns a String that represents the current Object.

Object)

unregister_channel This method disposes the Channel that corresponds to this Channel_Identifier in a Network.

write Overloaded. The write method sends data to the (Publishers)Network. It also does data validation according to the Networks Real Time XML Schemas.

Returns true if write was successful, returns false if channel is not registered.

Public Instance Events

On_Liveliness_Lost This event gets fired when the local Publisher has violated the Liveliness contract.

On_Offered_Deadline_Missed This event gets fired when a Publisher violates the Deadline contract for a specific Channel.

OnChannelGuideDataValidationError Fires when Channel Guide data being published does not conform to the Channel Guide Data Schema. Only Fires when Channel Guide Data Validation is on.

OnRealTimeDataValidationError Fires when Real Time data being Published does not conform to the Real Time Data Schema. Only Fires when Real Time Data Validation is turned on.

Explicit Interface Implementations

IPublisherListener.on_liveliness_lost

IPublisherListener.on_offered_deadline_missed

The Agent SDK Subscribe namespace contains the CoherentSet and Subscriber classes and the following delegates:
Subscriber.dChannelGuideDataValidationError;
Subscriber.don_broken_coherent_samples;
Subscriber.don_channel_destroyed;
Subscriber.don_coherent_samples;
Subscriber.don_liveliness_changed;
Subscriber.don_new_channels;
Subscriber.don_new_samples;
Subscriber.don_requested_deadline_missed;
Subscriber.dRealTimeDataValidationError.

CoherentSet

The CoherentSet class is a class that provides structured access to coherent sets of data, as defined by Publishers. Coherent Sets of data are then received by Subscribers, then the Subscribers Runtime automatically raise a Coherent_Data_Event when the full set has arrived. Each Coherent Set object is bound to a Subscriber(and therefore Network) so all data in this object is of one Schema type. However, Coherent Sets can arrive in an array(Coherent_Set[ ]), meaning that an entire Coherent Set is made of one or more Coherent_Set objects, which may well contain different types within each Coherent Set object.

As an illustration of implementation, the CoherentSet members are as follows:

Public Static (Shared) Methods

Equals (inherited from Object) Determines whether the specified Object instances are considered equal.

ReferenceEquals (inherited from Determines whether the specified Object instances

Object) are the same instance.

Public Instance Constructors

Coherent_Set Constructor

Public Instance Fields

concerned_subscriber The Subscriber that this Coherent Set is bound to.

samples_in_set Internal. Number of expected samples in this Coherent Set

set_id Internal. Uniquely identifies a Coherent Set.

Public Instance Properties

coherent_sample_set The set of coherent data samples.

Count The number of actual samples in this Coherent Set

is_full_set A check to see if this coherent set contains all expected data samples.

Public Instance Methods

Add Internal. Used to add samples belonging to this Coherent Set.

Equals (inherited from Object) Determines whether the specified Object is equal to the current Object.

GetHashCode (inherited from Serves as a hash function for a particular type,

Object) suitable for use in hashing algorithms and data structures like a hash table.

GetType (inherited from Object) Gets the Type of the current instance.

ToString (inherited from Object) Returns a String that represents the current Object.

Subscriber Namespace

Subscriber

Subscriber objects are bound to a specific Network for the entirety of their life. Subscriber has many QoS policies that describe how the Subscriber must behave once “enabled”. Most QoS policies are contracts between Publishers and the Network that must be enforced. Such contracts give the Subscriber an idea of what to expect from the Network. The TimeBasedFilterQosPolicy is specific to Subscriber—it instructs the Network to send only new real time information every minimum separation period or more. Subscriber provides read only access to automatically compiled schemas that correspond to the type of Agent Network—i.e. a temperature Subscriber would have a ‘Real-Time format’ temperature schema and a ‘Channel Guide format’ context schema. Subscriber objects also provide a way to set an x-Path query filter on the Network, so that real time information delivered to this specific Subscriber must meet a condition (i.e. “temperature >100”). Subscriber enables information to be read from a Network and has data validation process that ensures received information conforms to the Network from which it was received.

As an illustration of implementation, the Subscriber members are as follows:

Public Static (Shared) Properties

DefaultTimeout (inherited from the web service middleware

Microsoft.Web.Services2.Messaging.SoapClient)

Public Static (Shared) Methods

Equals (inherited from Object) Determines whether the specified Object instances are considered equal.

ReferenceEquals (inherited from Determines whether the specified Object instances are Object) the same instance.

Public Static (Shared) Events

On_Broken_Coherent_Set This Event delivers broken Coherent Sets of data, much the same as ‘On_New_Coherent_Set’ does. This Event occurs when all of the required data Samples from a Coherent Set do not arrive to the Subscriber within a specified period(default is 30 sec, set on RADDO site QoS page). The samples that are present are packaged into a Coherent Set(or more than one), along with an integer value on how many samples are missing from all sets combined, then fired through this Event.

On_New_Coherent_Set This Event delivers sets of data in much the same way ‘On_New_Samples’ does, except by delivering the set in a Coherent Set structure, the data coherency that the Publisher explicitly defined while ‘writing’ the data is preserved. This Event can contain one or more ‘coherent sets’ (in an array) that may or may not be from the same Subscriber(and therefore may have different Agent Network Schemas). It is the programmers responsibility to ensure that proper typing is enforced and that can be done by checking the Coherent Sets Subscriber property (and therefore Network type).

Public Instance Fields

enabled (inherited from

Agent.SDKPrivate.wseClientBase)

lifecycle_states Indicates the lifecycle of the Samples this Subscriber is interested in. Include the states you want, only samples with matching states will be delivered.

sample_states Controls the scope of samples downloaded from the Network. READ will retrieve previously read samples but not retrieve new samples. NOT_READ will retrieve new samples and not old. BOTH will retrieve all samples in the Networks history irregardless of read or not read. Default is NOT_READ, meaning all samples not read before by this Subscriber will be read.

ValidateChannelGuideData Turns Channel Guide Data Validation On/Off

ValidateRealTimeData Turns Real Time Data Validation On/Off

Public Instance Properties

Channel (inherited from the web service middleware

Microsoft.Web.Service2.Messaging.SoapSender)

Destination (inherited from the web service middleware

Microsoft.Web.Services2.Messaging.SoapSender)

dp (inherited from

Agent.SDKPrivate.wseClientBase

)

instance (inherited from

Agent.SDK_Private.wseClientBase

)

network the Network_Info object that corresponds to the Network that this Subscriber is bound to

Pipeline (inherited from the web service middleware

Microsoft.Web.Services2.Messaging.SoapPort)

qos The Quality of Service settings of this Subscriber.

Timeout (inherited from

Microsoft.Web.Services2.Messaging.SoapClient)

Public Instance Methods

AutoGetQos Sets the Networks QoS automatically. This represents the level of Qos that the Network Supports. If autoSetQos is set to true, the Subscribers QoS is automatically set to the Networks default. This does not require a returnCode as the Networks QoS cannot be incompatible with itself.

BeginSend (inherited from the web service middleware

Microsoft.Web.Services2.Messaging.SoapSender)

enable This starts the session of Subscription with a Network. Also marks the beginning of all automatic timers started for deadline, liveliness . . . Subscriber Events will be raised after this method call.

EndSend (inherited from the web

service middleware

Microsoft.Web.Services2.Messaging.SoapSender)

Equals (inherited from Object) Determines whether the specified Object is equal to the current Object.

GetHashCode (inherited from Serves as a hash function for a particular type,

Object) suitable for use in hashing algorithms and data structures like a hash table.

GetType (inherited from Object) Gets the Type of the current instance.

Send (inherited from the web service middleware

Microsoft.Web.Services2.Messaging.SoapSender)

set_xpath_filter This sets a filter on the Network that filters out data coming to this Subscriber. The xpath query must resolve to a boolean value for data to be delivered(true to be delivered, false to be discarded). The xpath query must be compatible with this Subscriber's Real-Time Payload schema in order to function. To reset the filter(allow all data_samples through this Subscriber), simply pass in a empty or null string.

SetQos Sets the Qos with manually, this QoS must be compatible with the Networks QoS which can be retrieved by AutoGetQos(false)

ToString (inherited from Object) Returns a String that represents the current Object.

Public Instance Events On_Channel_Destroyed This Event fires when a Channel has been unregistered(by a Publisher) or has violated its deadline QOS policy the maximum number of times and is due for automatic disposal.

On_Liveliness_Changed This event fires notifications when a Publisher violates its liveliness contract. Notifications includes the account that the Publisher was acting under

On_New_Channels Fires when new Channels have been created by any Publisher connected to this Subscribers Agent Network. This Event is guaranteed to fire its new Channels before it fires any new samples that correspond to the Channels gets fired.

On_New_Samples Fires when new samples are available for a Channel in this Subscribers Agent Network. This Event is guaranteed to only fire new samples that have a corresponding Channel(raised through the ‘New_Channel’ event).

On_Requested_Deadline_Missed This event fires when a Channel has violated its deadline QOS policy.

OnChannelGuideDataValidationError Fires when Channel Guide XML data being subscribed to does not conform to the Channel Guide Data Schema. Only Fires when Channel Guide Data Validation is on.

OnRealTimeDataValidationError Fires when Real Time XML data being subscribed to does not conform to the Real Time Data Schema. Only Fires when Real Time Data Validation is on.

Explicit Interface Implementations ISubscriberListener.on_channel_destroyed ISubscriberListener.on_data_available ISubscriberListener.on_liveliness_changed ISubscriberListener.on_requested_deadline_missed

Agent UI Module

Agent.UI Namespace

Some optional pre built controls that bring building of Agent based Applications to a higher level.

Classes

Class Description

Agent_System_InfoViewer Used to view and Join Agent_System_Infos and Networks. Also provides a UI for Setting QoS on one or more Networks before joining.

Login Use Login perform all security functionality and get your Agent_System_Infos. It fires an event when it has performed all this(OnLoginFailure, OnLoginSuccess).

QoSViewer A control that facilitates the setting of QoS through UI.

ServiceDomain Summary description for ServiceDomain.

Delegates

Delegate Description

Agent_System_InfoViewer.dOnJoinAgent_System_Info

Agent_System_InfoViewer.dOnJoinNetwork

Login.dLoginFailure

Login.dLoginSuccess

Enumerations

Enumeration Description

Agent_System_InfoViewerScope Used to control the scope of what is displayed in the Agent_System_Info window. Fires two events depending on users choice(OnJoinNetwork, OnJoinAgent_System_Info).

QosViewerScope All policies are in this control and the control can be tuned to show policies from Subscribers, Publishers, or Both using this enumeration

Agent.UI. ChatControls Namespace

Controls and classes that enable RAD of custom chat applications.

Classes

Class Description

ChatPayload This is the template class used to serialize and deserialize streams of real time data. It is the type for Channel_Guide_Data and for Real_Time_Data. You can see its schema definition at http ://www.thingtel.net/schema/ChatPayload.xsd

ChatPublisher ChatPublisher uses RADDO Appliances to publish chat Messages of type Chat Payload Schema found at http://www.Thingtel.net/schema/ChatPayload.xsd

ChatSubscriber ChatSubscriber uses RADDO Appliances to subscribe to chat Messages of type Chat Payload Schema found at http://www.Thingtel.net/schema/ChatPayload.xsd

Delegates

Delegate Description

ChatPublisher.dInterceptMessage

ChatPublisher.dOnChatMessage

ChatPublisher.dOnEnabled

ChatSubscriber.dInterceptMessage

ChatSubscriber.dOnEnabled

Agent. ULPolicies Namespace

Controls that expose atomic QoS policies through user interface.

Classes

Class Description

Cache The QoS applicable to this control can be accessed with its QoSControl.policy accessor.

Coherent The QoS applicable to this control can be accessed with its QoSControl.policy accessor.

Deadline The QoS applicable to this control can be accessed with its QoSControl.policy accessor.

DestinationOrder The QoS applicable to this control can be accessed with its QoSControl.policy accessor.

History The QoS applicable to this control can be accessed with its QoSControl.policy accessor.

LatencyBudget The QoS applicable to this control can be accessed with its QoSControl.policy accessor.

Liveliness The QoS applicable to this control can be accessed with its QoSControl.policy accessor.

LocationStamp The QoS applicable to this control can be accessed with its QoSControl.policy accessor.

Ownership The QoS applicable to this control can be accessed with its QoSControl.policy accessor.

Reliability The QoS applicable to this control can be accessed with its QoSControl.policy accessor.

Time The time value can be accessed with its Time.time accessor.

TimeBasedFilter The QoS applicable to this control can be accessed with its QoSControl.policy accessor.

TimeStamp The QoS applicable to this control can be accessed with its QoSControl.policy accessor.

Client/Server

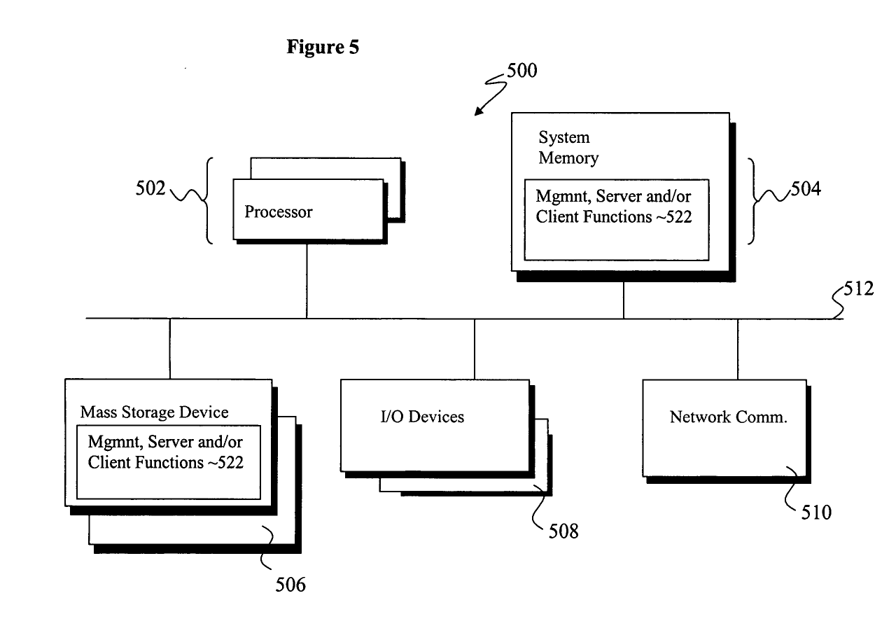

FIG. 5 illustrates an example computing device, suitable for use as either a Client 202, a Data Distribution Server 204, or a Management Server 210, in accordance with some embodiments. As illustrated, computing device 500 includes one or more processors 502, and system memory 504. It is anticipated that the capability of processors 502 and memory 504 will be appropriately scaled depending on whether computing device is used as a Client 202, a Data Distribution Server 204 or a Management Server 210. Additionally, computing device 500 includes mass storage devices 506 (such as diskette, hard drive, CDROM, DVD and so forth), input/output devices 508 (such as keyboard, cursor control and so forth) and communication interfaces 510 (such as network interface cards, modems and so forth). The elements are coupled to each other via system bus 512, which represents one or more buses. In the case of multiple buses, they may be bridged by one or more bus bridges (not shown).

Each of these elements performs its conventional functions known in the art. In particular, system memory 504 and mass storage 506 are employed to store a working copy and a permanent copy (not shown) of the programming instructions 524 implementing Client Application, Server Application, Management Server Application and/or Management Server Application.

The permanent copy of the programming instructions may be loaded into mass storage 506 in the factory, or in the field, through e.g. a distribution medium (not shown) or through communication interface 510 (from a distribution server (not shown)).

Except for Application 524, the constitution of elements 502-512 are known, and accordingly they will not be further described.

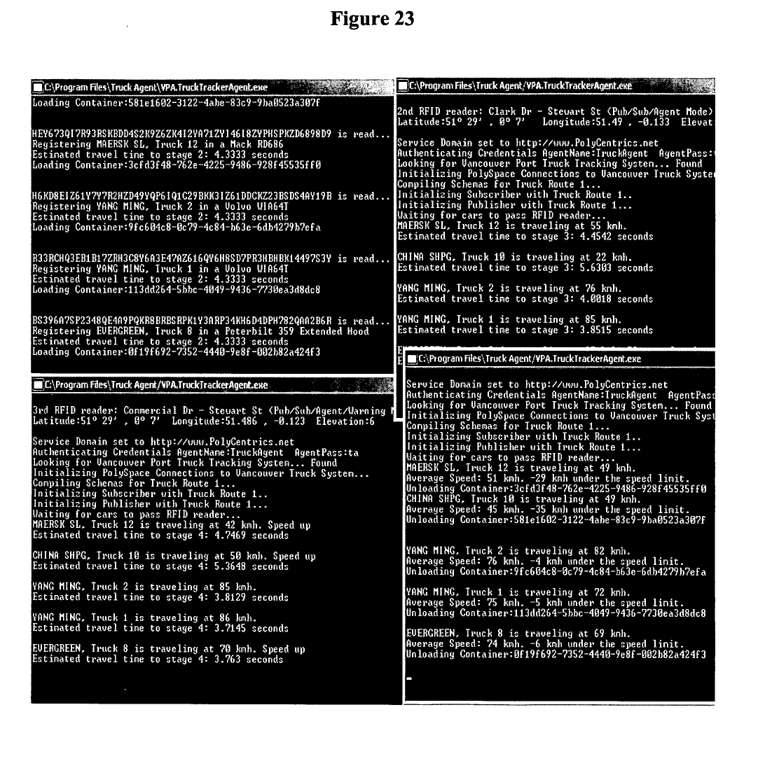

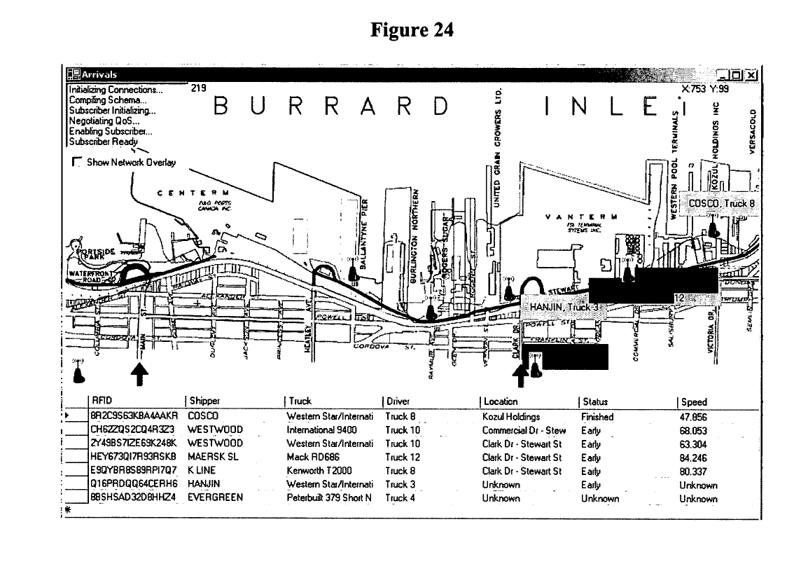

FIGS. 23-24 illustrate an Agent based Client/Agent applications, utilizing embodiments of the invention. More specifically, FIG. 23 illustrates real-time agent applications simulating integration with RFID readers located at different geographical locations. The “intelligent agents” integrated with the RFID readers read the RFID tags on trucks as they pass in real time by the telephone poles where the “intelligent agents” are installed. The agents in turn may use web services to access a remote database to interrogate information about the trucks identified. This extra and potentially other information is then bound into a formatter (XML) message stream by the agents when published. Each agent informs each other about trucks identified and using such information produced elsewhere enables the agents to calculate truck speed, etc.

FIG. 24 illustrates similar applications, where real-time agent based application showing RFID tagged trucks tracked as coloured blocks that move across an area map with real-time data grid below. Data is reported in real-time is subscribed from Networks that the RFID reader agents publish to.

As those skilled in the art would appreciate, such complex heterogeneous real time data publication, subscription and distribution, that otherwise would be difficult to implement under the prior art, may be implemented readily at ease, employing embodiments of the invention.

Thus, it can be seen from the above descriptions, various novel methods and apparatus for publishing, subscribing and distributing (real time) data, and networks formed employing these methods and apparatus, have been described. While the present invention has been described in terms of the earlier described embodiments, those skilled in the art will recognize that the invention is not limited to the embodiments described. The present invention can be practiced with modification and alteration within the spirit and scope of the appended claims of the non-provisional application to follow. Thus, the description is to be regarded as illustrative instead of restrictive on the present invention.

What is claimed is:

1. A networking method for distributing heterogeneous data in real time from one or more publishers of the heterogeneous data to one or more subscribers of the heterogeneous data, comprising:
receiving by a management server, a plurality of data schema or storage locations of the data schema, the data schema specifying a plurality of formats of the heterogeneous data to be distributed;
assigning by the management server, one or more servers, to facilitate routing of the data, through a plurality of channels, between a plurality of clients serving the one -or more publishers and one or more subscribers, the clients to dynamically join the one or more servers to form a network after the network has been initialized with the one or more servers;
initializing the network, by the management server, including transmitting the received data schema or storage locations of the data schema, to each of the assigned server(s) to enable each of assigned server(s) to facilitate routing of the data through the plurality of channels, in accordance with the data schema;
accepting the clients into the network, by the server(s), on demands of the clients, including transmitting or causing the data schema or storage locations of the data schema to be transmitted by the management server, to each of the accepted clients, the transmitting being performed substantially as the clients are accepted; and
facilitating routing of the data, by the server(s), from the one or more publishers, through the plurality of clients, to the one or more subscribers, the publishers and subscribers publishing and consuming the distributed data through the corresponding channels.

2. The method of claim 1, wherein the heterogeneous data are distributed in a marked up format.

3. The method of claim 1, further comprising receiving by the management server, descriptions for the heterogeneous data to be distributed in each of the plurality of channels, and transmitting, from the management server to the routing server(s) and from the management server or the routing server(s) to the accepted clients, the descriptions or storage locations of the descriptions.

4. The method of claim 1, further comprising receiving by the management server, a specification that each client serving publisher(s) of data distributed via a channel is to bind the data to points in time and/or space, and transmitting, from the management server to the routing server(s) and from the management server or routing server(s) to the accepted clients, the specification.

5. The method of claim 1, further comprising receiving by the management server, a specification that each client serving publisher(s) of data distributed via a channel is to bind the data to a thing, and transmitting, from the management server to the routing server(s) and from the management server or routing server(s) to the accepted clients, the specification.

6. The method of claim 5, wherein the specification includes information on how a client can resolve additional information related to what thing to bind the data distributed via the channel, and said transmitting of the specification comprises transmitting, from the management server to the routing server(s) and from the management server or routing server(s) to the accepted clients, the how to resolve information.

7. The method of claim 6, wherein the data distributed comprises sensor data, and the specification comprises instruction to binding the sensor data to a sensor, optionally including a location and/or an attribute of the sensor.

8. The method of claim 1, further comprising receiving by the management server, identification of the one or more servers, as server resource available for assignment to serve as data routing servers in a selected one of one or more heterogeneous real time data distribution networks.

9. The method of claim 8, further comprising receiving by the management server, management inputs to remotely manage the assigned server(s).

10. The method of claim 1, further comprising receiving by the management server, identifications of the clients, as client resource eligible to serve said publishers and/or subscribers of the network, and transmitting, from the management server to the routing server(s), the identifications of the clients.

11. The method of claim 10, further comprising receiving by the management server, management inputs to remotely manage the clients, the management inputs being received after the clients have joined the network.

12. The method of claim 1, further comprising receiving by the management server, one or more quality of service policy specifications specifying one or more quality of service policies to govern said distribution of heterogeneous data in the network; and transmitting, from the management server to the routing server(s) and from the management server or routing server(s) to the accepted clients, the one or more quality of service policy specifications.

13. The method of claim 12, wherein the one or more quality of service policy specifications include one or more quality of service specifications selected from the group consisting of:
a specification of a policy controlling a high water mark for a deadline for distributing a value of a data instance, to be met or exceeded by each publisher of the data instance;
a specification of a policy controlling how each subscriber is to resolve and determine a final value of a data instance that is published by multiple publishers;
a specification of a policy controlling a high water mark for a number of historic values of a data instance an assigned server can commit to a subscriber;
a specification of a policy controlling a high water mark for a latency in distributing a value of a data instance from a publisher to a subscriber, a publisher can request;
a specification of a policy controlling a high water mark for an amount of elapsed time in between liveliness signaling by each publisher, to be met or exceeded by each publisher;
a specification of a policy controlling whether the channels are shared or reserved for exclusive use by creators of the channels;
a specification of a policy controlling whether the channels are shared or reserved for exclusive use by creators of the channels;
a specification of a policy controlling a high water mark for a reliability level an assigned server can commit to a subscriber;
a specification of a policy controlling a high water mark for a level of filtering of values of a data instance an assigned server can commit to a subscriber;
a specification of a policy controlling how the distributed heterogeneous data is to be time stamped; and
a specification of a policy controlling how the distributed heterogeneous data is to be time stamped.

14. The method of claim 1, further comprising receiving by the management server, specifications of an organization, a plurality of users, and a plurality accounts, including their interrelationship and operational roles with respect to the network.

15. A network comprising:
one or more publishers of first one or more organizations to publish data;
one or more subscribers of second one or more organizations to subscriber to the data;
a plurality of clients selectively coupled to the one or more publishers, and the one or more subscribers, to service the publisher(s) and subscriber(s);
one or more servers to dynamically accept the clients into the network, on demand, and facilitate routing of the data in real time, from the publisher(s) to the subscriber(s), through the clients; and
a management server coupled to the server(s) to provide the server(s) specifications of the organizations, a plurality of users, and a plurality accounts, including their interrelationship and operational roles with respect to the network, the one or more servers to dynamically accept the clients based at least in part on the provided specifications.

16. The network of claim 15, wherein at least one of the first one or more organizations and at least one of the second first one or more organization, are different organizations.

17. The network of claim 15, wherein the data are heterogeneous data distributed in a formatted manner, and the management server is further adapted to provide the server(s) and the clients, directly or through the server(s), one or more data schema or storage location of the data schema, the data schema specifying data format of the data, and the data schema or storage locations of the data schema being pre-provided to the server(s) on initialization of the network, prior to the clients establishing connections to the server(s).

18. The network of claim 15, wherein the data are distributed in a plurality of channels;
the management server is adapted to receive descriptions for the data to be distributed in each of the plurality of channels, and to transmit the received descriptions to each of the one or more servers; and
each of the one or more servers is adapted to receive the descriptions, and to transmit or cause the descriptions to be transmitted by the management server to a client, after the server accepts the client into the network.

19. The network of claim 15, wherein
the management server is adapted to receive a specification that each client serving publisher(s) of data distributed via a channel is to bind the data to points in time and/or space, and to transmit the received specification to each of the one or more servers;
each of the one or more servers is adapted to receive the specification, and to transmit or cause the specification to be transmitted by the management server to a client, after the server accepts the client into the network; and
each of the clients is adapted to receive the specification, and to bind the data distributed via the channel to points in time and/or space, as specified by the specification.

20. The network of claim 15, wherein the management server is adapted to receive a specification that each client serving publisher(s) of data distributed via a channel is to bind the data to a thing, and to transmit the received specification to each of the one or more servers;
each of the one or more servers is adapted to receive the specification, and to transmit or cause the specification to be transmitted by the management server to a client, after the server accepts the client into the network; and
each of the clients is adapted to receive the specification, and to bind the data distributed via the channel to a thing, as specified by the specification.

21. The network of claim 15, wherein the management server is adapted to receive identification of the one or more servers, as server resource available for assignment to serve as data routing servers in a selected one of one or more heterogeneous real time data distribution networks.

22. The network of claim 21, the management server in further adapted to receive management inputs for remotely managing the server(s), and to remotely manage the server(s) based at least in part on the received management inputs.

23. The network of claim 15, the management server is adapted to receive identifications of the clients, as client resource eligible to serve said publishers and/or subscribers of the network, and to transmit to the server(s), the identifications of the clients.

24. The network of claim 23, wherein the management server is adapted to receive management inputs for remotely managing the clients, and to remotely manage the clients based at least in part on the received management inputs, the management inputs and the management being received and performed after the clients have joined the network.

25. The network of claim 15, wherein
the management server is adapted to receive one or more quality of service policy specifications specifying one or more quality of service policies to govern said distribution of heterogeneous data in the network, and to transmit the one or more quality of service policy specifications to the server(s);
each of the server(s) is adapted to receive the one or more quality of service policy specifications, to transmit or cause the one or more quality of service policy specifications to be transmitted by the management server to the clients serviced by the server, to negotiate applicable ones with the clients serviced by the server, and to route data in accordance with the one or more quality of service policy specifications as negotiated; and
each of the clients is adapted to receive the one or more quality of service policy specifications from the servicing server, to negotiate applicable ones with the servicing server, and to transmit and/or receive data in accordance with the one or more quality of service policy specifications as negotiated.

26. A method to be performed by a management server comprising:
receiving by the management server, a plurality of data schema or storage locations of the data schema for a network for distributing heterogeneous data in a formatted manner and in real time through a plurality of channels from one or more publishers of the heterogeneous data to one or more subscribers of the heterogeneous data, the data schema specifying a plurality of formats of the heterogeneous data to be distributed;
assigning by the management server, one or more servers to facilitate routing the data between a plurality of clients serving the one or more publishers and one or more subscribers, the clients to be dynamically accepted by the one or more servers, on demand, to form the network, after initialization of the network; and
initializing the network, by the management server, including transmitting the received data schema or storage locations of the data schema, to each of the assigned server(s) to enable each of assigned server(s) to facilitate the routing in accordance with the data schema.

27. The method of claim 26, further comprising receiving by the management server descriptions for the heterogeneous data to be distributed in each of the plurality of channels, and transmitting by the management server to at least the routing server(s) the descriptions or storage locations of the descriptions.

28. The method of claim 26, further comprising receiving by the management server, a specification that each client serving publisher(s) of data distributed via a channel is to bind the data to points in time and/or space, and transmitting by the management server to the routing server(s), the specification.

29. The method of claim 26, further comprising receiving by the management server, a specification that each client serving publisher(s) of data distributed via a channel is to bind the data to a thing, and transmitting by the management server to the routing server(s), the specification.

30. The method of claim 29, further wherein the specification includes information on how a client can resolve additional information related to what thing to bind the data distributed via the channel, and said transmitting of the specification comprises transmitting, from the management server to the routing server(s) and from the management server or routing server(s) to clients accepted into the network by the server(s), the how to resolve information.

31. The method of claim 26, further comprising receiving by the management server, identification of the one or more servers and/or the clients, as server resource available for assignment to serve as data routing servers in a selected one of one or more heterogeneous real time data distribution networks, and as client resource eligible to serve said publishers and/or subscribers of the network, and transmitting, from the management server to the routing server(s), the identifications of the clients, if received.

32. The method of claim 31, further comprising receiving by the management server, management inputs to remotely manage the assigned server(s) and/or clients, the management inputs for remotely managing the clients being received after the clients have joined the network.

33. The method of claim 26, further comprising receiving by the management server, one or more quality of service policy specifications specifying one or more quality of service policies to govern said distribution of heterogeneous data in the network; and transmitting, from the management server to the routing server(s), the one or more quality of service policy specifications.

34. The method of claim 26, further comprising receiving by the management server, specifications of an organization, a plurality of users, and a plurality accounts, including their interrelationship and operational roles with respect to the network.

35. An apparatus comprising:
one or more processors; and
a storage medium coupled to the one or more processors, having a plurality of programming instructions to be executed by the processor(s), to enable the apparatus to:
receive a plurality of specifications of one or more organizations, a plurality of users, and a plurality accounts, including their interrelationship and operational roles with respect to a network for distributing data from one or more publishers of the data of first one or more organizations to one or more subscribers of the data of second one or more organizations,
assign one or more servers to facilitate routing the data between a plurality of clients serving the one or more publishers and one or more subscribers, the one or more servers to dynamically accept the clients into the network based at least in part on the received specifications; and
initialize the network, including transmitting the received specification, to each of the assigned server(s) to enable each of assigned server(s) to facilitate the routing.

36. The apparatus of claim 35, wherein at least one of the first one or more organizations and at least one of the second first one or more organization, are different organizations.

37. The network of claim 35, wherein the data are heterogeneous data distributed in a formatted manner, and the apparatus is further adapted to provide the server(s) and the clients, directly or through the server(s), one or more data schema or storage location of the data schema, the data schema specifying data format of the data, and the data schema or storage locations of the data schema being pre-provided to the server(s) on initialization of the network, prior to the clients establishing connections to the server(s).

38. The apparatus of claim 35, wherein the data are distributed via a plurality of channels, and the programming instructions are further adapted to receive descriptions for the data to be distributed in each of the plurality of channels, and to transmit the received descriptions to each of the one or more servers.

39. The apparatus of claim 35, wherein the data are distributed via a plurality of channels, and the programming instructions are further adapted to receive a specification that each client serving publisher(s) of data distributed via a channel is to bind the data to points in time and/or space, and to transmit the received specification to at least each of the one or more servers.

40. The apparatus of claim 35, wherein the data are distributed via a plurality of channels, and the programming instructions are further adapted to receive a specification that each client serving publisher(s) of data distributed via a channel is to bind the data to a thing, and to transmit the received specification to at least each of the one or more servers.

41. The apparatus of claim 40, wherein the specification includes information on how a client can resolve additional information related to what thing to bind the data distributed via the channel, and said transmitting of the specification comprises transmitting, from the apparatus to the routing server(s) and from the apparatus or routing server(s) to clients accepted into the network by the server(s), the how to resolve information.
